(19) United States
(12) Patent Application Publication
(10) Pub. No.: US 2025/0371278 A1
(43) Pub. Date: Dec. 4, 2025

(54) AI-ASSISTED TRANSCRIPT INTEGRATION FOR SOFTWARE APPLICATIONS

(71) Applicant: SAP SE, Walldorf (DE)

(72) Inventors: Jens Schyma, Forst (DE); Dan Fan, Basel (CH); Philipp Schreiner, Landau in der Pfalz (DE); Deepu Sajan, Friedrichshafen (DE); Robin Herder, Bad Waldsee (DE); Lukas Tobias Fink, Herbertingen (DE)

(73) Assignee: SAP SE, Walldorf (DE)

(21) Appl. No.: 18/677,542

(22) Filed: May 29, 2024

(51) Int. Cl. G06F 40/35; G06F 40/40

(52) U.S. Cl. CPC G06F 40/35; G06F 40/40

(57) ABSTRACT

An intelligent assistant incorporating a Large Language Model (LLM) can transform a transcript containing communications regarding tasks into structured data. The transcript can be a meeting transcript or a transcript of a chatbot chat that was autonomously initiated by the intelligent assistant to obtain additional information regarding a task. With LLM assistance, the intelligent assistant transforms unstructured communication data from the transcript into structured data which is then assigned to relevant task objects stored in a database. Prior to processing a transcript, personal data therein can be sanitized, and the intelligent assistant can divide the transcript into smaller segments which each encapsulate a discussion of a different topic.

### FIELD

The field generally relates to integrating text transcripts of online meetings and chat sessions in software applications with assistance from generative artificial intelligence (AI).

### BACKGROUND

Project management software applications aim to maintain updated information regarding projects and their associated tasks. Current project status and risk information is typically discussed by team members in meetings, such as daily status update meetings. However, this information must be manually entered by the team members involved, which can be a time-consuming and tedious process. As a result, it is often completed incompletely or irregularly.

The project manager is usually responsible for manually updating the project management application with the most recent status information. This task can significantly detract from their primary role of managing the project.

### BRIEF DESCRIPTION OF THE DRAWINGS

FIG. 1 is a block diagram of a high-level view of an example system implementing AI-assisted transcript integration for a project management application.

FIG. 2 is a block diagram of a detailed view of an example system implementing AI-assisted transcript integration for a project management application.

FIG. 3 is a flowchart of an example high-level method of performing AI-assisted integration of unstructured communication data with a project management application.

FIG. 4 is a flowchart of an example detailed method of performing AI-assisted integration of unstructured communication data with a project management application.

FIG. 5 is a block diagram of an example user interface (UI) for accepting a task status update for an existing task object in conjunction with the technologies described herein.

FIG. 6 is a flowchart of an example method of adding a new task in a project management application via AI-assisted processing of unstructured transcript data.

FIG. 7 is a block diagram of an example UI for accepting a task status update for creating a new task object in conjunction with the technologies described herein.

FIG. 8 is a block diagram of an example system for generating predictions via a trained AI model to assist integration of unstructured communication data in a project management application.

FIG. 9 is a block diagram of an example process for dividing a transcript into segments in conjunction with the technologies described herein.

FIG. 10 is a flowchart of an example method of dividing a transcript into segments in conjunction with the technologies described herein.

FIG. 11 is a flowchart of an example method of sanitizing personal data in a transcript prior integrating data from the transcript in a project management application.

FIG. 12 is flowchart of an example method of employing an AI-assisted chatbot to obtain clarification of task information in conjunction with the technologies described herein.

FIG. 13 is a block diagram of an example UI for accepting a task status update generated based on a chatbot-initiated chat in conjunction with the technologies described herein.

FIG. 14 is a block diagram of an example computing system in which described embodiments can be implemented.

FIG. 15 is a block diagram of an example cloud computing environment that can be used in conjunction with the technologies described herein.

### DETAILED DESCRIPTION

### Example 1)—Overview

Generative AI models such as large language models (LLMs) now have the capability to convert unstructured data, such as meeting and chat transcripts, into summary form. Techniques are described herein for mapping and assigning LLM-generated summaries of unstructured communication data (e.g., transcripts of meetings or chats) to relevant data objects within the structured environment of a project management application (e.g., a Cloud-based project management software application).

For example, an intelligent project assistant (IPA) incorporating an LLM can receive unstructured communication data from existing online communication tools. With LLM assistance, the IPA transforms the unstructured communication data into structured data which is then assigned to relevant data objects within the project management application. Optionally, the IPA can employ an LLM to sanitize personal data from the unstructured communication data before it is processed and mapped to the existing task objects. The IPA is alternatively referred to herein as an “intelligent assistant.”

When a transcript received from an online communication tool is too lengthy for effective LLM-assisted processing, the IPA can perform a containerization technique to split the transcript into shorter segments. For example, techniques are described herein for dividing a transcript into segments that each encapsulate a discussion of a different topic. The segments can then be processed individually to integrate the communication data therein with data objects stored in the project management application.

The IPA can also proactively assist with project management by interacting with project team members via chat to gather the latest status updates. For example, the IPA can include a chatbot which can engage in a chat with a user to obtain answers to open questions regarding a task assigned to the user.

The LLM can take the form of an AI or machine learning model that is designed to understand and generate human language. Such models typically leverage deep learning techniques such as transformer-based architectures to process language with a very large number (e.g., billions) of parameters. Examples include the Generative Pre-trained Transformer (GPT) developed by OpenAI (e.g., ChatGPT), Bidirectional Encoder Representations from Transforms (BERT) by Google, A Robustly Optimized BERT Pretraining Approach developed by Facebook AI, Megatron-LM of NVIDIA, or the like. Pretrained models are available from a variety of sources. Optionally, the LLM can also be trained using information associated with the project management system.

The described technologies thus offer considerable improvements over conventional techniques for updating task status information in a project management application. For example, the techniques described herein can reduce the need for project teams and managers to manually take notes during meetings and transfer the information to the project management application, thus allowing them to focus on more complex tasks within the project.

While examples specific to project management application are discussed herein, the disclosed techniques can also be applied to other types of software systems or applications.

### Example 2)—High-Level System

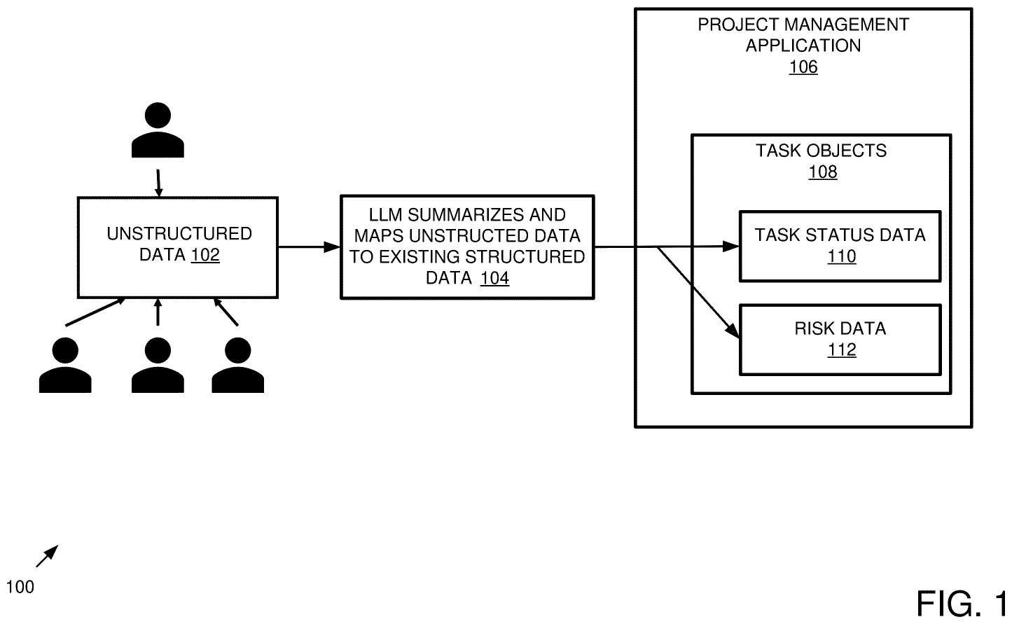

FIG. 1 is a block diagram of an example system 100 implementing AI-assisted transcript integration for a project management application. In the example, the system 100 receives, as an input, unstructured data 102 representing communications between users (e.g., project team members) in text form. The unstructured data 102 can include a transcript of a meeting or call, a transcript of an online chat session or instant messenger dialog, or a text representation of another type of communication between one or more of the users. The unstructured data 102 can be generated by an online communication tool such as an online meeting platform (e.g., automatically or in response to a request to transcribe the meeting or call). Alternatively, the transcript can be generated by applying a speech-to-text model to a recording of a remote or onsite meeting or call, or generated in another manner.

The unstructured data 102 serves as an input to an LLM, which summarizes and maps the unstructured data to existing structured data at 104. The existing structured data can include data objects stored in a database of a project management application 106, such as task objects 108. Each task object 108 can be a stored representation of a corresponding task associated with a project. As described herein, discussion or mention of discrete entities such as tasks can be identified in the unstructured data and mapped to corresponding task objects 108. Towards this end, the LLM can be employed to assist with mapping portions of the unstructured data 102 to respective corresponding task objects 108. For example, the LLM can assist with identifying a portion of the unstructured data that constitutes task status data 110 and risk data 112 for a given task object 108, and this portion of the unstructured data 102 can then be incorporated in the corresponding task object 108 (e.g., as a status update for the task object 108). In addition, the LLM can identify a portion of the unstructured data that describes a new task for a given project and propose adding a new task object including the corresponding data.

Herein, the terms “project” and “task group” may be used interchangeably. Each project or task group may be associated with a plurality of tasks.

Any of the systems herein, including the system 100, can comprise at least one hardware processor and at least one memory coupled to the at least one hardware processor.

The system 100 can also comprise one or more non-transitory computer-readable media having stored therein computer-executable instructions that, when executed by the computing system, cause the computing system to perform any of the methods described herein.

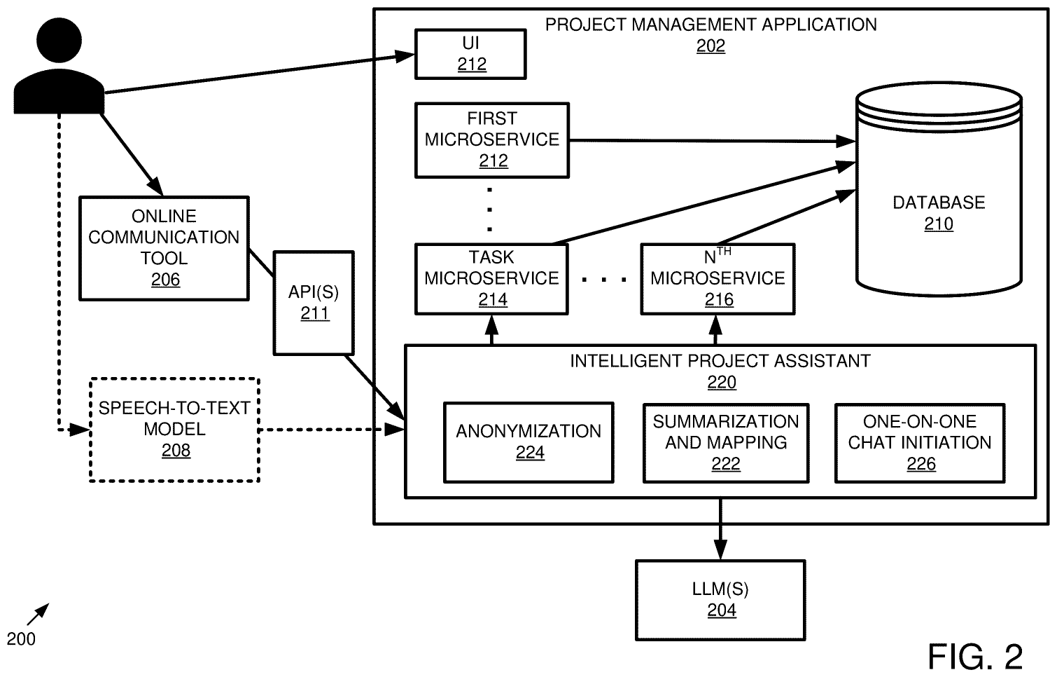

In practice, the systems shown herein, such as system 100, can vary in complexity, with additional functionality, more complex components, and the like. For example, the project management application 106 can include additional components such as those described herein with reference to FIG. 2.

The described computing systems can be networked via wired or wireless network connections, including the Internet. Alternatively, systems can be connected through an intranet connection (e.g., in a corporate environment, government environment, or the like).

The system 100 and any of the other systems described herein can be implemented in conjunction with any of the hardware components described herein, such as the computing systems described below (e.g., processing units, memory, and the like). In any of the examples herein, the unstructured data 102, task objects 108, task status data 110, risk data 112, and the like can be stored in one or more computer-readable storage media or computer-readable storage devices. The technologies described herein can be generic to the specifics of operating systems or hardware and can be applied in any variety of environments to take advantage of the described features.

### Example 3)—Detailed System

FIG. 2 is a block diagram of a detailed view of an example system implementing AI-assisted transcript integration for a project management application. In the example, the system 200 includes a project management application 202, one or more LLM(s) 204, an online communication tool 206, and one or more API(s) 211. Optionally, the system 200 can also include a speech-to-text model 208 in addition to or instead of the online communication tool 206.

Project management application 202 can include a Cloud-based application based on a microservice architecture with various microservices catering to specific functions within the project management application. In the example, the project management application 202 includes a plurality of microservices comprising at least a first microservice 212, a task microservice 214, and an n^{th} microservice 216. As shown, data used in the project management application is stored in structured form in a database 210, which is communicably coupled with the plurality of microservices.

The task microservice 214 and the n^{th} microservice 216 are in turn communicably coupled with an IPA 220, which can be a microservice or an embedded service. The IPA 220 can be configured to handle unstructured data related to communications between users (e.g., project team members), such as unstructured text in the form of a transcript. The communication data may originate from the online communication tool 206, which can incorporate different technologies and provide different forms of communication such as meetings, emails, chat, calls, etc. In particular, the online communication tool 206 may include functionality which generates text transcripts of speech recorded during the communications. The online communication tool 206 can supply the communications to the IPA 220 via push mechanisms, such as events, or make them available via one or more API(s) 211 where they can be polled from the IPA 220. Accordingly, the IPA can act as a bridge between the online communication tool and the project management application 202. Alternatively, the text data can also be retrieved using speech-to-text model 208, which can be run to transform spoken language into digitalized text.

The project management application 202 then applies the one or more LLM(s) 204 to process the text data. The LLM(s) 204 may either be run within the project management application 202 itself or be consumed via Cloud services from an external provider. The LLM(s) 204 may be off-the-shelf general purpose generative AI models which have been trained to analyze and interpret unstructured text data. In such examples, the training data for the LLM(s) 204 can include data from the Internet, books, and public-accessible source code, among other data. Utilizing such off-the-shelf LLMs may be advantageous due to the considerable costs (e.g., effort and computation needs) associated with training custom LLMs. Alternatively, the LLM(s) 204 may include one or more custom LLM(s). In such examples, the training data for the LLM(s) 204 can also include data associated with the project management application 202, such as data stored in the database 210.

As described further herein, one or more LLMs 204 are applied to extract information relevant for project management from the text data and then map the extracted information against the existing objects in the database 210 (e.g., via summarization and mapping functionality 222 of the IPA 220). For example, an LLM 204 can transform unstructured data pertaining to a particular task into structured data. The structured data generated by the LLM for a given task can include, for example, a summary of the text regarding the task, next actions for the task, and a risk indication for the task.

The LLM-generated structured data may be presented to a user of the project management application (e.g., a project manager) via a UI for approval (e.g., in the form of a status update to an existing task or a new task). Upon approval, the structured data is stored in the project management application and made available for display to users of the project management application via the UI.

As shown, the IPA 220 can include additional functionality including anonymization 224 and one-on-one chat initiation 226. For example, the IPA 220 can anonymize (e.g., sanitize) the unstructured data by removing personal data or other confidential information prior to mapping the unstructured data against the existing objects in the database 210. Towards this end, the IPA can apply a different, specialized LLM 204 which s trained to compliantly deal with personal data to remove personal data from the transcript.

Further, the IPA 220 can initiate a one-on-one chat to obtain information from a user of the project management application 202, as described further herein. During the chat, the IPA 220 can employ an LLM 204 to formulate messages to display in the chat. In this context, the IPA 220 may be alternatively referred to a chatbot incorporating an LLM (or an AI-assisted chatbot).

In the example, IPA 220 is depicted as being part of the project management application 202. In other examples, however, the IPA 220 can instead be an external component which is optionally shared with one or more other applications (e.g., other Cloud applications).

As indicated, the system 200 may include a single LLM or a plurality of LLMs (or other types of machine learning models). For example, a single multi-functional LLM may be employed, or different types of machine learning models may be employed which provide different types of assistance. Each model can either be run within the system 200 (e.g., within the project management application 202) or be consumed via Cloud services from an external provider.

### Example 4)—Example High-Level Method Performing AI-Assisted Integration of a Transcript with a Project Management Application

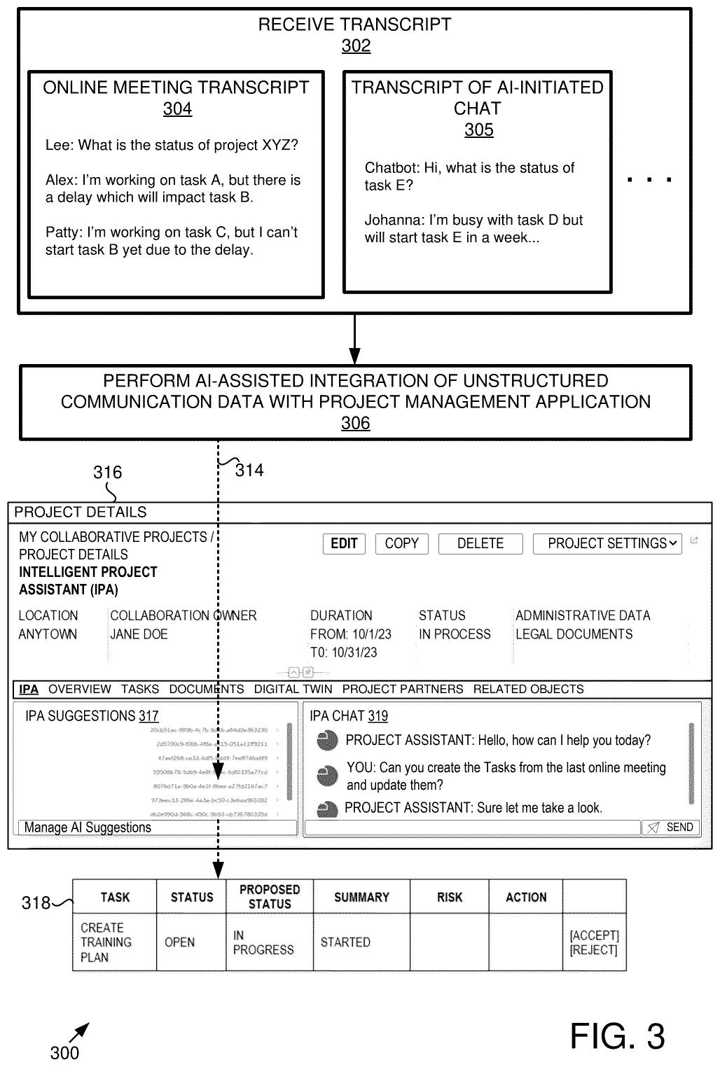

FIG. 3 is a flowchart of an example method 300 performing AI-assisted integration of a transcript with a project management application and can be performed, for example, by the system of FIG. 2.

In the example, at 302, a transcript is received. The transcript may be an online meeting transcript 304, a transcript of an AI-initiated chat 305, or another form of unstructured communication data that includes transcribed text (e.g., a transcript of a user-initiated chat) and metadata (e.g., start and end times of the meeting/chat, an indication of who is speaking at a given time, etc.). Alternatively, the transcript may be a transcript of an onsite meeting which was recorded (e.g., in an audio or video recording). The transcript may be received from an online communication tool such as online communication tool 206. For example, the online meeting transcript 304 may be generated by the online communication tool hosting the meeting and output (e.g., via an API) to a project management application. Alternatively, the transcript may be received in another manner (e.g., an audio transcript of an onsite meeting may be uploaded from a recording device).

At 306, the transcript received at 302 is integrated with a project management application with assistance from AI. The integration process, which is described in further detail below, can include mapping the transcript to a project and prompting an LLM to generate a structured output for each task discussed in the transcript. The tasks can then be mapped to corresponding task objects stored in a database of the project management system, and the discussion of the tasks can be transformed into proposed updates for existing task objects or proposed new task objects. In either case, the proposed update or proposed new task object is displayed to a user via a UI, and the user is prompted to accept, adjust, or reject the entity. For example, as indicated by the dashed arrow 314, the proposed updates to the existing task objects or proposed new task objects can be presented as IPA suggestions 317 in list form in a UI 316 of the project management application. The user can select (e.g., click on or otherwise activate) each suggestion to obtain further details and either accept, adjust, or reject the suggestion.

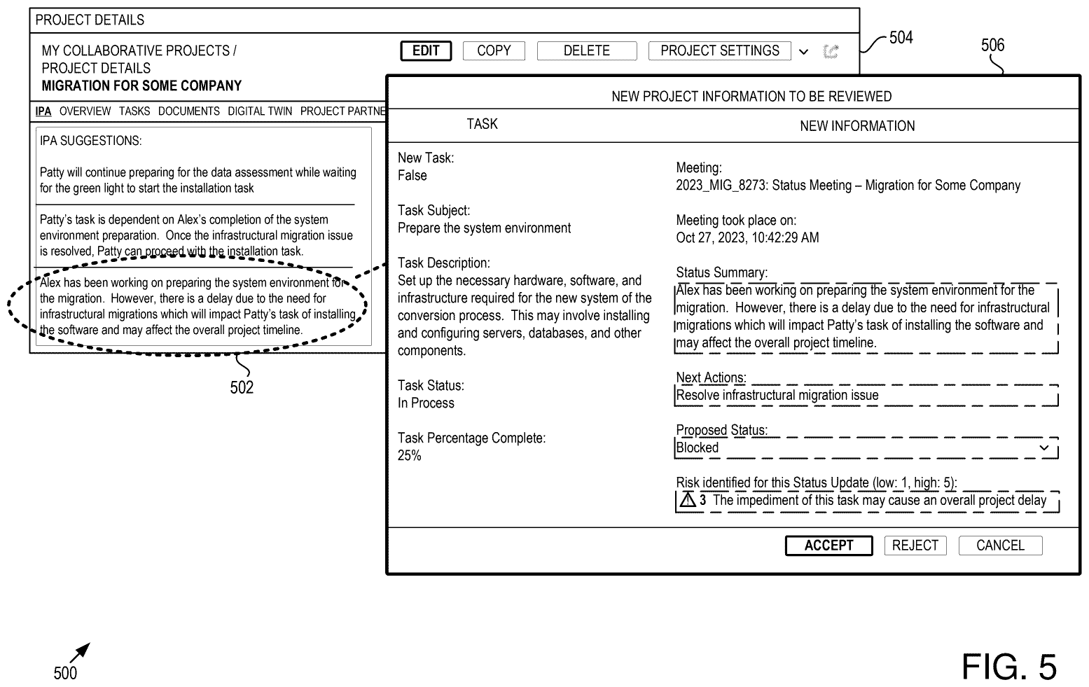

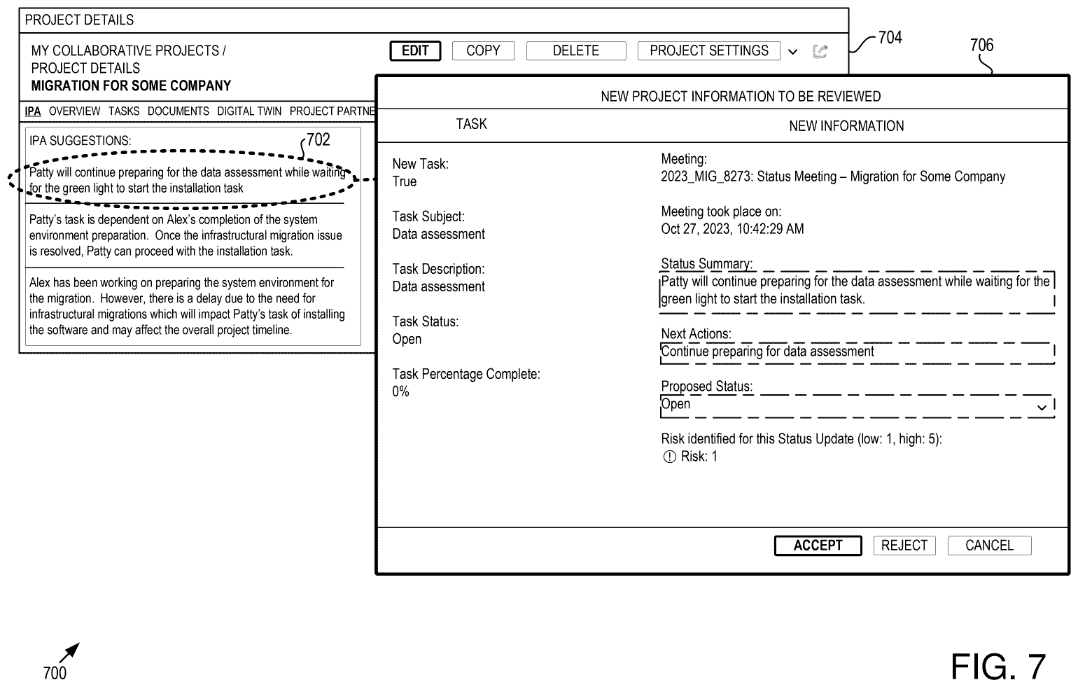

An example of further details that may be displayed to the user for a proposed update to an existing task object is shown at 318. In particular, the IPA suggests that the status of a “create training plan” task be updated from “open” to “in progress,” and requests that the user either accept or reject the status update. While the depicted IPA suggestions 317 have each suggestion represented as a string of letters and numbers, the suggestions can alternatively be displayed in a more legible format (e.g., as shown in FIGS. 5 and 7). In response to the user accepting the suggestion, the database can be updated with data from the entity (e.g., the corresponding task object can be updated with data from the status update entity, or a new task object can be created and populated with data from the new task entity).

In the example, the UI 316 further includes an IPA chat 319, in which a user (e.g., a project manager) can interact with the IPA to request that the IPA perform specified actions. As shown, the user has requested that the IPA create tasks from the last online meeting (e.g., the meeting regarding project XYZ associated with online meeting transcript 304). In response, the IPA can perform the techniques described herein to generate proposed updates to existing task objects or proposed new task objects, which in turn are displayed as IPA suggestions 317. The IPA suggestions 317 can be clicked on, reviewed, and accepted, adjusted (and then accepted), or rejected.

In other examples, the IPA may generate the IPA suggestions 317 without being prompted by a user (e.g., at predetermined time intervals or in response to specified events). Alternatively or additionally, as described herein, the IPA may be configured to identify a need for clarification regarding certain tasks and proactively initiate an LLM-assisted chat with associated users (e.g., project team members assigned to the tasks) to obtain the clarification (e.g., to obtain answers to one or more open questions identified by the LLM regarding the task). The suggestions may then be generated and displayed based on answers received during the chat.

The method 300 and any of the other methods described herein can be performed by computer-executable instructions (e.g., causing a computing system to perform the method) stored in one or more computer-readable media (e.g., storage or other tangible media) or stored in one or more computer-readable storage devices. Such methods can be performed in software, firmware, hardware, or combinations thereof. Such methods can be performed at least in part by a computing system (e.g., one or more computing devices).

The illustrated actions can be described from alternative perspectives while still implementing the technologies. For example, receiving a request can be described as sending a request depending on perspective.

### Example 5)—Example Detailed Method Performing AI-Assisted Integration of a Transcript with a Project Management Application

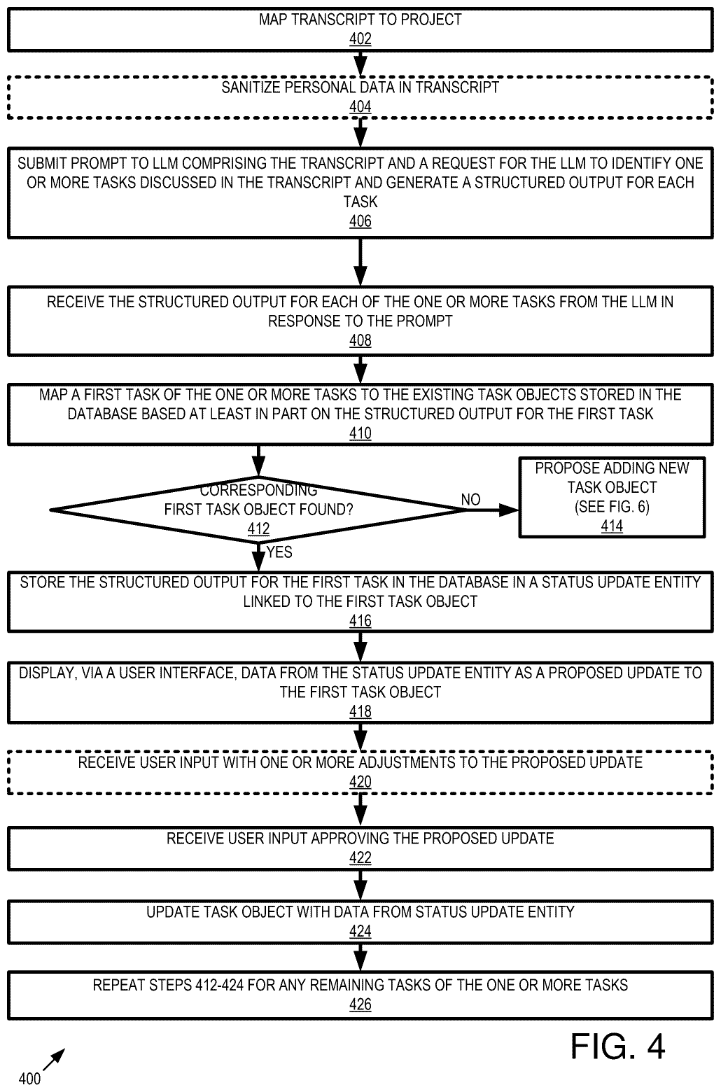

FIG. 4 is a flowchart of an example detailed method 400 of performing AI-assisted integration of a transcript with a project management application and can be performed, for example, by the system of FIG. 2 and in conjunction with method 300 of FIG. 3. For example, method 400 may be performed at step 306 of FIG. 3.

At 402, a transcript is mapped to a corresponding project of the project management application. The transcript may be received from an online communication tool via an API, for example, and may include text transcribed from audio of an online meeting or a text transcript of a chat session or other online message exchange (e.g., a transcript of an email exchange). Assigning the transcript to the correct project when it is received can advantageously minimize the relevant information space and facilitate LLM processing during subsequent steps.

Several different techniques may be used to map the transcript to the corresponding project. As one example, the user who organized a meeting from which the transcript was generated may be tasked with providing a clear unique mapping between the meeting and the project when scheduling the meeting using the online communication tool, e.g., by inputting an identifier of the project into a field associated with the meeting (and thus, the transcript of the meeting) in the online communication tool. In some examples, the online communication tool may be configured to prompt the meeting organizer to establish a link between the meeting and a corresponding project during scheduling of the meeting.

As another example, the meeting organizer may be prompted to select the corresponding project from a list of projects after the meeting (e.g., prompted by the online communication tool, or by the IPA of the project management application). Alternatively, the IPA may infer which project is the corresponding project, e.g., by analyzing a list of attendees of the meeting and searching for active projects in the project management application which have identical or nearly identical attendees.

As yet another example, the IPA may prompt an LLM to predict the corresponding project. Towards this end, the IPA can submit a prompt to the LLM including information regarding the meeting such as a name of the meeting, a description of the meeting, attendees of the meeting, and a short list of potentially relevant projects. The short list may include all running (active) projects where at least the meeting organizer is involved. Alternatively, other techniques for generating the short list may be used. Similar approaches can be used for transcripts of events other than meetings such as chats.

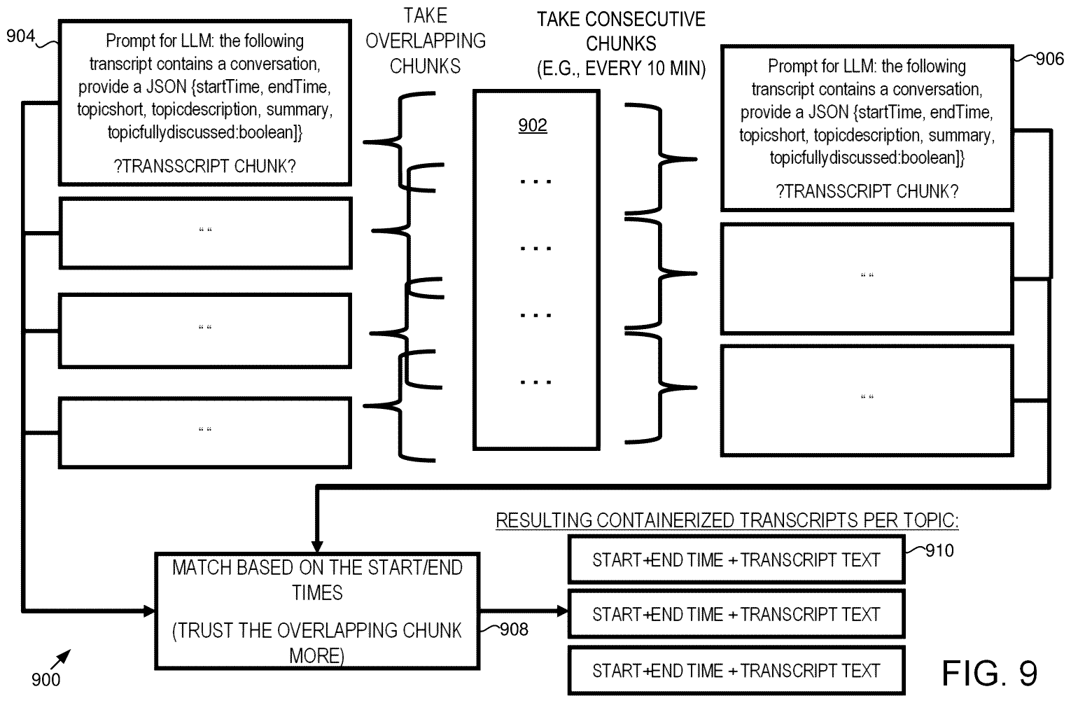

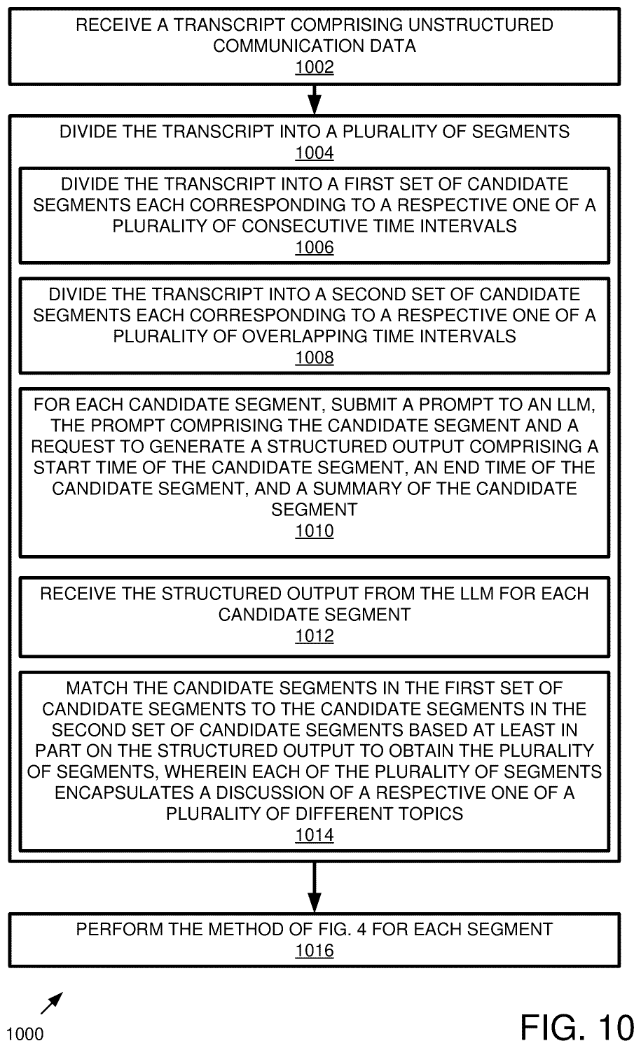

Depending on the length of the transcript, a containerizing process may be performed (e.g., before or after mapping the meeting to the corresponding project) to divide the transcript into smaller segments which are more easily processed by an LLM. Example containerizing processes are described further herein with reference to FIGS. 9-10.

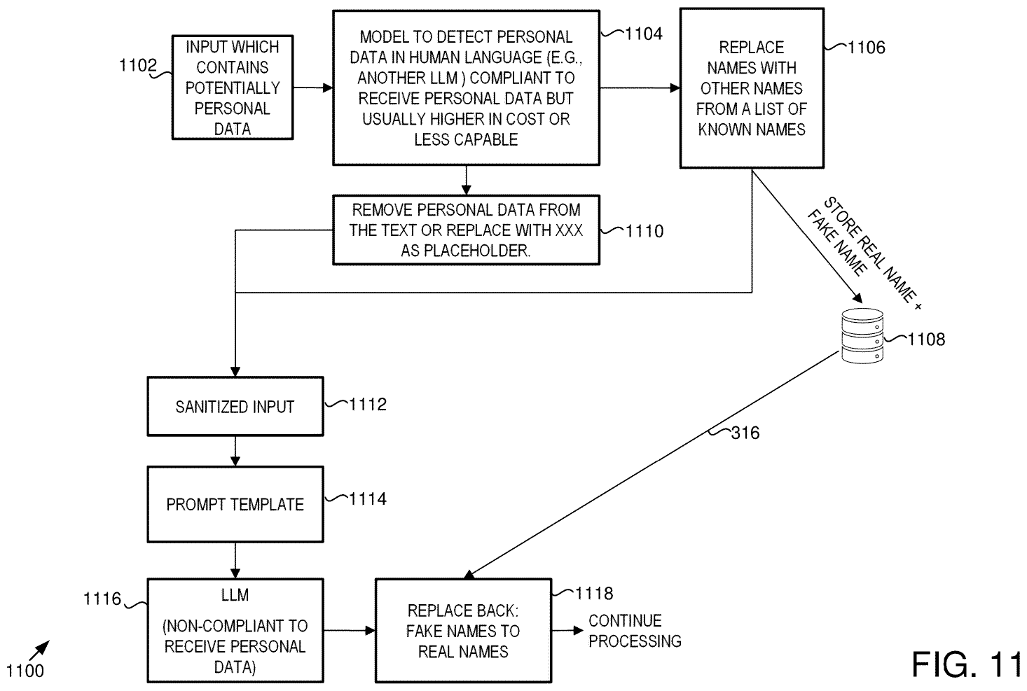

Optionally, at 404, the transcript is sanitized so as to remove or obfuscate any personal data discussed during the meeting. Sanitizing the transcript can include, for example, manually replacing names in the transcript with random fake names or applying an LLM which is trained to compliantly deal with personal data to remove personal data from the transcript. An example process for sanitizing a transcript is described herein with reference to FIG. 11.

At 406, a prompt is submitted to an LLM which includes the transcript (e.g., the sanitized transcript) and a request for the LLM to identify one or more tasks discussed in the transcript and generate a structured output for each task. The prompt can be submitted to the LLM by an IPA such as IPA 220 of FIG. 2. The request can specify that the structured output for each task should include values for a plurality of keys specified in the prompt. The keys can include, for example, one or more of the following: a current status of the task, a proposed status change for the task, a start time and an end time of discussion of the task in the transcript, a name of a user to whom the task is assigned, a summary of the discussion of the task (e.g., a summary of topics discussed regarding the task), a risk rating or indication for the task (which may include reasons for the risk rating/indication), a name of the task, and/or possible next actions for the task (e.g., actions required for completion of the task). Other keys which are not specified here may also be included.

The prompt to the LLM can also include, for one or more of the keys, a description of how the values included in the structured output should be formatted for the key, and/or a specification of acceptable values for the key. Further, the prompt can specify that data (e.g., the structured output) be output by the LLM in a structured format such as JavaScript Object Notation (JSON), extensible Markup Language (XML), or Comma Separated Values (CSV).

An example prompt which may be submitted to an LLM at step 406 may look like this:
“Generate a list of discussed tasks in the following meeting notes. Provide the discussed tasks in a JSON Array with the following keys: \n “task”, “assignedto”, “status”, “summaryoftopicdiscussed”, “ratings”, “riskreason”, “actionrequired”.\n “summaryoftopicdiscussed” value should include comprehensive updates of each task. \n “rating” should range from 1 (no risk) to 5 (high risk of failure, timeline/budget problems) \n “status” is one the following status: “None”, “Blocked”, “Open”, “In progress”, “Completed”, “OK”, “Not OK”. \n Meeting notes: ? THEMEETINGTRANSSCRIPT?”.

A single example prompt is described in step 406 for ease of explanation. However, in practice, multiple prompts may be used instead of a single prompt. Accordingly, in any of the examples described herein, references to “a prompt” can be understood to refer to either a single prompt or multiple prompts. For example, the information described as being included in a single prompt may instead by spread across multiple prompts (e.g., transcript data may be spread across multiple prompts such that one chunk of a transcript is sent in a first prompt, another chunk of the transcript is sent in a second prompt, etc.).

At 408, a structured output for each of the one or more tasks is received from the LLM in response to the prompt. For instance, the example prompt above would provide a JSON array containing a structured output for each task (e.g., a data object for each task) which includes values for the keys specified in the prompt in the format specified in the prompt (and with one of the possible values specified in the prompt, where applicable).

At 410, the method includes mapping a first task of the one or more tasks to the existing task objects stored in a database (e.g., a database of a project management application) based at least in part on the structured output for the first task. This can include, for example, generating a prompt for an LLM to search the task objects stored in the database for a corresponding task object that matches the first task in some way. The corresponding task object may be a task object having data attributes that match or are similar to one or more data attributes of the first task. Examples of data attributes of a given task include a task name derived from the transcript, a status update summary for the task, the name of one or more people who discussed the task. The data attributes for the first task may be specified in, or determined based on, the structured output for the first task. The data attributes for the first task which are to be used to find the corresponding task object can be included in the prompt.

The prompt can also include a list of existing tasks stored in the database which are associated with the project. Depending on the size of the project, the list of all existing task objects stored in the database for the project may be too large to be suitably processed by the LLM. To address this issue, the list of all existing task objects included in the prompt may be pre-processed to reduce the number of entries therein such that the list of existing task objects included in the prompt is a smaller subset of all existing task objects stored in the database. The pre-processing may include filtering the existing task objects stored in the database for the project. For example, the existing task objects stored in the database for the project may be filtered based on at least one of: a creation date; an edit date; a status; a latest comment; a latest status update; or a name of an associated user.

Alternatively, the pre-processing may include using embeddings to generate a shorter list of existing task objects associated with the project, which can later be referenced to determine whether the existing task objects therein were talked about in a given meeting or chat. In particular, a respective embedding vector may be pre-created for each individual existing task object based at least in part on data attributes of the existing task object. This can include assigning a respective multi-dimensional vector value to input text (e.g., descriptive text) for each existing task object. The descriptive task for a given existing task object may include data attributes such as the title, the task description, any previous comments on the task (e.g., comments manually entered by team members), and/or previous summaries of meeting status updates on the associated task. The embedding vectors may be stored with relation to the respective existing task objects.

A search embedding vector can then be created for the first task to be mapped using different strategies, such as by using the full meeting transcript section identified for the task, only the summary created, or only the textual description of the task. The list of existing task objects to be included in the prompt can then be generated by retrieving a predefined number of the existing task objects stored in the database whose embedding vectors are most closely related to the search embedding vector generated for the first task (e.g., the top n tasks having the closest relation to the search embedding vector for the first task).

The list of existing task objects included in the prompt can include, for each existing task object, a link of a unique identifier (e.g., a UUID, a GUID, or a freely chosen identifier which can be remapped to the original UUID) for the task object. Optionally, the link can include full task details for the task object (e.g., a description or a summary thereof, which may have been pre-created by another LLM prompt and stored to the task object).

The prompt can include a request that the results be structured in a parseable format such as JSON, XML or CSV. Additionally, the prompt can ask the LLM to decide if there is an indication that users are already aware of the task (and thus, that a corresponding task object is already stored in the project management system) or an indication that users are not aware of the task (and thus, that the task is likely a new task without a corresponding existing task object stored in the database).

An example prompt which may be submitted to an LLM at step 410 may look like this:

```
“Update the json file ?JSON_CONTENT_OF_TASKS? with the taskid
from the following data. ?LIST_OF_TASKS_AND_IDS? If task from
json file cannot be found in the following data, assign the taskid to
empty String and return the updated json file.”
?JSON_CONTENT_OF_TASKS? = [
  { taskid:null, name:”Project Planning”, summary:”The schedule
is finished.”},
  {taskid:null, name:”Prepare Training”, summary:”Started to
create the training content.”}
]
?LIST_OF_TASKS_AND_IDS? = [
  { taskid:”1234”, name:”Planning”},
  { taskid:”6734”, name:”Training Planning”},
  { taskid:”3434”, name:”Execution”}
]
```

Alternatively or additionally, other data from the structured output for the first task can be included in the prompt and used by the LLM to find a match for the first task among the existing task objects. The LLM prompted for the mapping can be the same LLM used to generate the structured output at 406, or a different LLM.

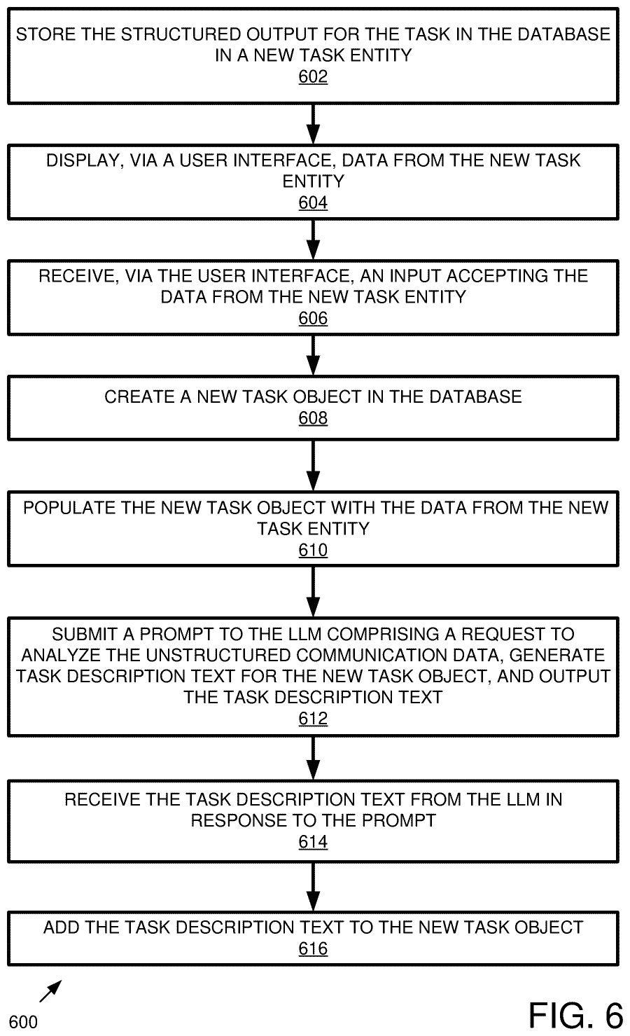

At 412, a determination is made as to whether a corresponding first task object for the first task was located in the database. For example, the determination may be performed by the IPA based on the output of the LLM in response to the prompt. If the answer at 412 is NO, indicating that a corresponding first task object has not been identified in the database, the method proceeds to 414 to suggest adding a new task object for the first task, as described further below with reference to FIG. 6.

Otherwise, if the answer at 412 is YES, indicating that a corresponding first task object has been identified in the database, the method proceeds to 416. At 416, the structured output for the first task is stored in the database in a status update entity linked to the first task object. At 418, the method includes displaying, via a UI, data from the status update entity as a proposed update to the first task object. This is optional and may be adjustable based on user preferences (e.g., a user may configure the application such that status update entities are automatically accepted). An example UI displaying a proposed update to a task object is described below with reference to FIG. 5.

Optionally, at 420, user input with one or more adjustments to the proposed update is received (e.g., one or more adjustments to the data from the status update entity). For example, a user may agree with some aspects of the proposed update, whereas other aspects may be inaccurate. The UI can present the data from the status update entity in an editable format such that the user can click in one or more fields to edit the data (e.g., to edit the values of the keys).

At 422, user input is received which approves the proposed update. For example, the user may click an “accept” button in the UI to accept the proposed update. The proposed update being accepted may be the original proposed update displayed at 418 (e.g., if no adjustments were made at 420), or a modified version of the proposed update which incorporates any adjustments made at 420.

In other examples, a user may reject the proposed update (e.g., by clicking a “reject” button in the UI). In such examples, the status update entity may be discarded, or the user may be prompted to either adjust the status update entity or provide reasons why the proposed update was rejected.

After receiving the user input approving the proposed update, the method proceeds to update the first task object with data from the status update entity at 424. Updating the first task object with the data from the status update entity can include, for example, updating one or more task attributes of the first task object based on the data from the status update entity.

At 426, steps 412-424 are repeated for any remaining tasks of the one or more tasks (e.g., steps 412-424 are performed for a second task, then steps 412-424 are performed for a third task, etc. until all tasks discussed in the transcript have been processed). Alternatively, multiple tasks may be processed in tandem.

In examples where the transcript has been containerized (e.g., divided into segments), method 400 or a subset of the steps of method 400 may be performed for each segment of the transcript.

### Example 6)—Example UI Displaying a Proposed Update to a Task Object

FIG. 5 is a block diagram of an example UI 500 displaying a proposed update to a task object. For example, a UI similar to UI 500 may be displayed at step 418 of FIG. 4.

In the example, a meeting has recently been conducted regarding a project entitled “Migration for Some Company” using an online communication tool which automatically generated a text transcript of the meeting. The IPA of the project application received the transcript from the online communication tool following the meeting, and processed the transcript to generate proposed status updates for existing task objects for tasks associated with the project and/or proposed new task objects associated with the project.

Subsequently, a user (e.g., a project manager) has accessed a project details page (e.g., by drilling down from a main menu of a project management application) to verify that all discussions from the meeting were appropriately documented by the IPA. The project details page is displayed in a UI 504 which displays and allows editing of project details for the “Migration for Some Company” project. The project details page now reveals several status updates that were generated by the IPA from the meeting transcript in the form of a list of IPA suggestions.

In the example, the user has selected (e.g., clicked on) an IPA suggestion 502 displayed in the list of IPA suggestions” In the example, the list of IPA suggestions displays a brief status summary for each suggestion; in other examples, the displayed suggestion may include other information. The selection of the IPA suggestion 502 has spawned a pop-up window 506 displaying new project information to be reviewed which is related to the IPA suggestion 502. As indicated, the suggestion has been generated from a transcript of a meeting entitled “Status Meeting—Migration for Some Company” regarding the project (here, an identifier “2023_MIG_8273” of the project is listed rather than the full project name).

In the example, the information in pop-up window 506 is divided into a Task column and a New Information column. The Task column displays an indication of whether the suggestion is related to a new task; a description of the subject of the task associated with the suggestion, a current status of the task, and a current completion percentage of the task. The New Information column displays a project identifier for the project which was discussed during the meeting from whose transcript the suggestion was derived, a title of the meeting, a date and time of the meeting, a proposed status summary for the task associated with the suggestion, proposed next actions for the task associated with the suggestion, and a proposed status for the task associated with the suggestion, and a risk rating and associated reasoning for the task associated with the suggestion.

In the example, the information displayed in window 506 includes a proposed status summary generated by the IPA based on a transcript of the meeting. The proposed status summary indicates that project team member Alex has been working on the task “Prepare the system environment” but there is a delay due to the need for infrastructural migrations, which in turn will impact project team member Patty's task of installing the software and may affect the overall project timeline.

The information displayed in window 506 also includes proposed next actions generated by the IPA based on the transcript of the meeting. In the example, the proposed next action suggested by the IPA is to “Resolve infrastructural migration issue.” Further, a proposed status generated by the IPA based on a transcript of the meeting is displayed in window 506; in the example, the proposed status is “Blocked.” Accordingly, after processing the transcript with LLM assistance, the IPA suggest changing the status of the “Prepare the system environment” task from “In Process” to “Blocked.” A risk rating and corresponding reasoning is also displayed in window 506; in the example, a risk rating of 3 has been assigned, with the reasoning that the impediment of the task may cause an overall project delay.

The window 506 displays the proposed new information to be incorporated in the corresponding task objects in editable fields, as indicated by the dashed lines. Accordingly, the user can select (e.g., click on or otherwise activate) each editable field to adjust the suggestion as appropriate. This can include, for example, typing different information in the status summary, next actions, and risk fields, or selecting a different proposed status from a dropdown menu. After making any adjustments, the user can either accept, reject, or cancel the proposed updates by selecting the corresponding UI element (e.g., graphical button). If the user cancels the proposed updates, the suggestion remains on the list of proposed updates and may be acted upon later. In response to the user accepting the proposed update, the database can be updated with the suggested data, e.g., by incorporating the suggested data (as modified by any adjustments) in the corresponding task object.

In other examples, a proposed update to a task object may be presented to a user (e.g., project manager) in a different way than is depicted in FIG. 5 or at a different stage. For example, the proposed update may be displayed via an email, via a chat notification, or in another manner (or not at all if the user opted to automatically accept all proposals made).

### Example 7)—Example Method of Adding New Task Objects Via AI-Assisted Processing of a Transcript

FIG. 6 is a flowchart of an example method 600 of adding new task objects in a project management application via AI-assisted processing of a transcript and can be performed, for example, by the system of FIG. 2. Method 600 may be performed in conjunction with method 400 (e.g., at step 412 of method 400 as indicated).

Accordingly, method 600 may be performed after it has been determined that a task discussed in the transcript does not have a corresponding task object stored in a database of the project management application.

At 602, the structured output for the task (e.g., the structured output received at step 408 of method 400) is stored in the database in a new task entity.

At 604, data from the new task entity is displayed via a UI (e.g., as a proposed new task object). An example UI displaying a proposed new task object is described below with reference to FIG. 7.

At 606, an input accepting the data from the new task entity is received via the UI. At 608, a new task object is created in the database in response to the input accepting the data from the new task entity. The new task object is populated with the data from the new task entity at 610.

Additional steps may be performed to add additional data to the new task object. Towards this end, at 612, the method includes submitting a prompt to the LLM which includes a request for the LLM to generate task description text for the new task object. The prompt can include the relevant portion of the transcript in which the new task was discussed, the summary of the new task included in the structured output for the new task, and/or other information.

At 614, the task description text is received from the LLM in response to the prompt. The task description text is added to the new task object at 616.

### Example 8)—Example UI Displaying Proposed New Task Objects

FIG. 7 is a block diagram of an example UI 700 displaying a proposed new task object. For example, a UI similar to UI 700 may be displayed at step 604 of FIG. 6.

In the example, a user (e.g., a project manager) has selected (e.g., clicked on) an IPA suggestion 702 displayed in a list of IPA suggestions in a UI 704, which corresponds to UI 504 of FIG. 5. The selection of the IPA suggestion 702 has spawned a pop-up window 706 displaying new project information to be reviewed which is related to the IPA suggestion 702. Window 706 includes information similar to that described above with reference to window 506 of FIG. 5.

As indicated in window 706, the IPA has identified that the task associated with the IPA suggestion 702 is a new task (New Task: True), as opposed to a task associated with an existing task object stored in the database of the project management application. The IPA has generated a proposed status summary, proposed next actions, proposed status, and proposed risk for the new task “Data assessment” based on a transcript of the meeting “Status Meeting-Migration for Some Company” regarding the project with identifier “2023_MIG_8273.”

The proposed status summary generated by the IPA indicates that project team member Patty will continue preparing for the “Data assessment” task while waiting for green light to start an “Installation” task. Accordingly, the proposed next action suggested by the IPA is “Continue preparing for data assessment,” the proposed status is “Open,” and the risk identified is 1 (i.e., low risk). Here again, the window 506 displays the proposed new information to be incorporated in the proposed new task object in editable fields such that the user can select each editable field to adjust the suggestion as appropriate. After making any adjustments, the user can either accept, reject, or cancel the new task object by selecting the corresponding UI element.

In response to the user accepting the new task object, the database can be updated by adding a new task object which incorporates the suggested data (as modified by any adjustments).

In other examples, a proposed new task object may be presented to a user (e.g., project manager) in a different way than is depicted in FIG. 7 or at a different stage. For example, the proposed new task object may be displayed via an email, via a chat notification, or in another manner.

Additional features which are not shown can also be incorporated in the UI 700.

### Example 9)—Example System Training an AI Model

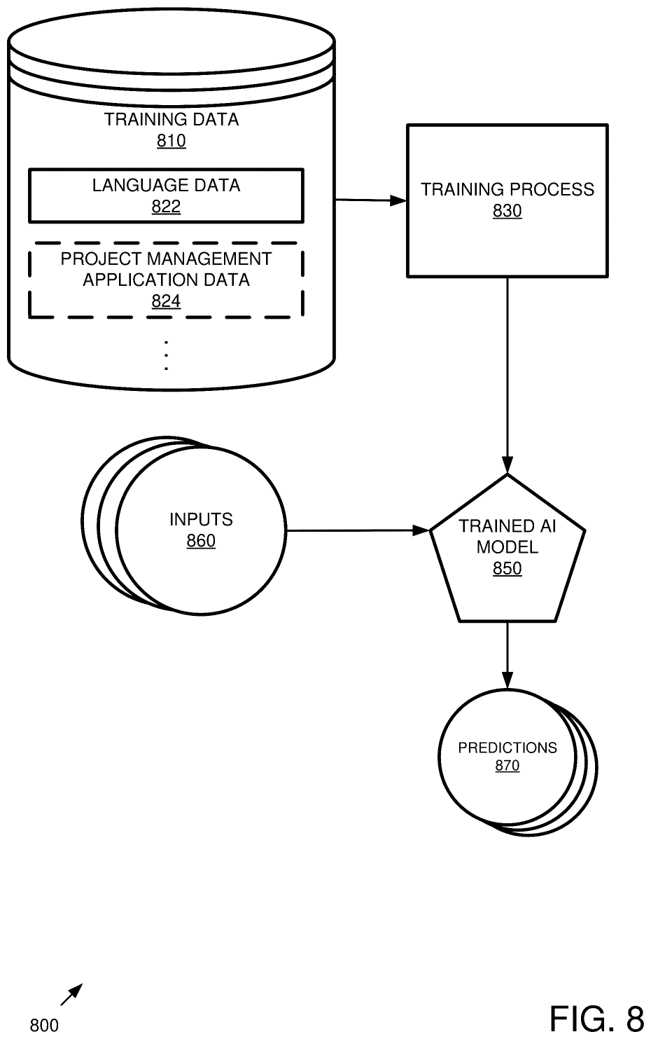

FIG. 8 is a block diagram showing an example system 800 training an AI model 850 for use in any of the examples herein. In the example, a project management application can include an IPA which utilizes one or more AI models (e.g., LLMs or other machine learning models) to analyze unstructured communication data (e.g., transcript data) and generate suggestions for integrating the data in data objects (e.g., task objects associated with project tasks) stored in the project management application.

In the example, training data 810 is input to a training process 830 that produces the trained AI model 850. As shown, training data 810 can include language data 822. For example, the trained AI model 850 may be an off-the-shelf generative AI model which has been trained using language data 822 and has not undergone any training specific to the project management application. In other examples, however, the trained AI model 850 may be a custom model which includes other training data 810 such as project management application data 824.

The trained AI model 850 accepts one or more inputs 860 and generates one or more predictions 870. The inputs 860 can correspond to the various prompts described herein (e.g., the prompt submitted at step 406 of FIG. 4 and the prompt submitted at step 612 of FIG. 6). As described herein, the predictions 870 generated by the model can assist with integration of a transcript with a project management application. For example, an IPA (e.g., IPA 220 of FIG. 2) can be configured to prompt an AI model for predictions and use the predictions to generate proposed updates to existing task objects or proposed new task objects to be stored in a database of a project management application.

### Example 10—Example Training Data

In any of the examples herein, training data for an AI model can come from a variety of sources. The training data can include language data (e.g., language data 822 of FIG. 8), which can enable the AI model to conduct a natural dialog with a user. For example, language data can include data scraped from the Internet, books, and other media sources. The AI model may be an off-the-shelf generative AI model, in which case all training may be performed by another entity (and not by the project management application).

However, optionally, the training data may also include data specific to an application or platform (e.g., project management application data 824 of FIG. 8). For example, for a given project management application (e.g., project management application 202 of FIG. 2), the training data specific to the project management application can include task objects.

Any training data specific to the project management application can also include observed (e.g., historical) data. The observed data can include metrics observed during prior execution of the project management application

It will be appreciated that the training data for the trained AI model can include significantly more training data and test data so that predictions can be validated. There can also be additional functionality within the training process.

### Example 11—Example Training Process

In any of the examples herein, training can proceed using a training process that trains the AI model using available training data. In practice, some of the data can be withheld as test data to be used during model validation.

Such a process typically involves feature selection and iterative application of the training data to a training process particular to the AI model. After training, the model can be validated with test data. An overall confidence score for the model can indicate how well the model is performing (e.g., whether it is generalizing well).

In practice, machine learning tasks and processes can be provided by machine learning functionality included in a platform in which the system operates. For example, in a database context, training data can be provided as input, and the embedded machine learning functionality can handle details regarding training.

### Example 12—Example Process for Dividing a Transcript into Segments

FIG. 9 is a block diagram an example process 900 of dividing a transcript into segments and can be performed, for example, by the system of FIG. 2. The dividing process is alternatively referred to herein as “containerizing” of the transcript, in that the resulting segments of the transcript encapsulate and thus contain discussion of respective topics. Process 900 may be performed in conjunction with method 300. For example, the transcript received at step 302 of method 300 may be a segment of a longer transcript which was divided via process 900.

Transcripts of communications such as online meetings can be very long and include discussion of many topics one after the other. Current LLM technology may have trouble processing the large amount of text in a transcript in one go. For example, current LLMs may work best with a small prompt input size and may not allow such a large input text. Further, current LLMs may be less precise in responding to prompts and may tend to lose focus. However, it may be unnecessary to process the all the information in a transcript from the beginning to the end. Rather, depending on the meeting length and total number of words spoken, it may be beneficial to divide the transcript into individual containerized segments (e.g., “chunks”). Accordingly, process 900 may be performed to divide a transcript into smaller chunks or segments which each encapsulate discussion of one or more topics. In this way, LLMs can assist with processing of the data in the transcript in piecewise manner (e.g., one segment at a time), without losing any information or context.

As shown, a meeting transcript 902 can be divided into a plurality of overlapping chunks 904 and a plurality of consecutive chunks 906. Each of the overlapping chunks 904 may include transcribed text from a time period during the meeting which overlaps with another time period from which the transcribed text is included in another one (or more) of the overlapping chunks 904. The overlapping chunks 904 may represent different meeting time durations from one another, or some or all of the overlapping chunks 904 may correspond to a same meeting time duration. In contrast, the consecutive chunks 906 may include transcribed text from consecutive time periods each having a same specified duration, e.g., 10 minutes or another duration.

A prompt may be submitted to an LLM for each of the consecutive chunks 906 (referred to as a first set of candidate segments corresponding to respective one of a plurality of consecutive time intervals) and for each of the overlapping chunks 904 (referred to as a second set of candidate segments corresponding to a respective one of a plurality of overlapping time intervals). For example, the IPA may generate and submit the prompt for each candidate segment. The LLM receiving the prompts may be the same LLM used in other aspects of the AI-assisted transcript integration described herein, or a different LLM.

The prompt for each candidate segment can include the segment itself (i.e., the transcribed text therein) and a request for the LLM to generate a structured output for the candidate segment comprising a start time of the candidate segment, an end time of the candidate segment, and a summary of the candidate segment, among other data. An example prompt which may be submitted to an LLM may look like this:
Prompt for LLM: the following transcript contains a conversation, provide a JSON {startTime, endTime, topicshort, topicdescription, summary, topicfullydiscussed: boolean]}?TRANSCRIPT CHUNK?

At 908, the structured outputs received from the LLM in response to the prompts can be matched by the IPA to obtain containerized chunks or segments for further processing. This can include, for example, matching the candidate segments in the first set of candidate segments to the candidate segments in the second set of candidate segments. For example, in a first step, all segments of the first set of candidate segments (i.e., all the consecutive chunks 906) are taken. Next, the last candidate segment of the first set of candidate segments, which ends at the end time of the meeting transcript 902, is selected and the start timestamp of that candidate segment is used to choose the next closest segment of the second set of candidate segments (i.e., a respective one of the overlapping chunks 904). The process is then repeated for the second-to-last candidate segment of the first set of candidate segments, and so on, until all of the candidate segments of the first set of candidate segments have been processed.

As a result of the matching, a plurality of segments 910 are generated from the transcript. Each segment 910 encapsulate a discussion of a respective one of a plurality of different topics is obtained. As indicated, each segment 910 includes a start time, and end time, and the transcript text corresponding to the time period between the start time and end time. The transcribed text within the segments 910 can then be integrated in the project management application one by one, e.g., by iteratively performing method 400 for each segment 910.

### Example 13—Example Method of Dividing a Transcript into Segments

FIG. 10 is a flowchart of an example method 1000 of dividing a transcript into segments and can be performed, for example, by the system of FIG. 2. Method 1000 may be performed in conjunction with, and overlap with, process 900 of FIG. 9.

At 1002, a transcript comprising unstructured communication data is received. The transcript is divided into a plurality of segments at 1004. As indicated, dividing the transcript into a plurality of segments includes dividing the transcript into a first set of candidate segments each corresponding to a respective one of a plurality of consecutive time intervals at 1006 and dividing the transcript into a second set of candidate segments each corresponding to a respective one of a plurality of overlapping time intervals at 1008.

At 1010, dividing the transcript into a plurality of segments further includes, for each candidate segment, submitting a prompt to an LLM. The prompt can include the candidate segment and a request to generate a structured output for the candidate segment comprising a start time of the candidate segment, an end time of the candidate segment, and a summary of the candidate segment. Dividing the transcript into a plurality of segments further includes receiving the structured output from the LLM for each segment at 1012, and at matching the candidate segments in the first set of candidate segments to the candidate segments in the second set of candidate segments at 1014. As indicated, the matching is based at least in part on the structured outputs for the first set of candidate segments to obtain the plurality of segments, wherein each segment of the plurality of segments encapsulates a discussion of a respective one of a plurality of different topics.

At 1016, the method includes performing the method of FIG. 4 for each segment. For example, each of the plurality of segments generated via the containerizing process can serve as an input to method 400 such that the data therein is integrated in the project management application (e.g., as an update to an existing task object or as a new task object).

### Example 14—Example Method of Sanitizing Transcript Data

FIG. 11 is a flowchart of an example method 1100 of sanitizing transcript data and can be performed, for example, by the system of FIG. 2. Method 1100 may be performed in conjunction with method 400 of FIG. 4 (e.g., at step 404 of method 400 as indicated).

In some circumstances, the data sent to LLMs is prohibited from containing personal data. This may be for legal reasons, as the provider of the LLM may not fulfil the required standards to process the data. However, a LLM that is compliant to receive personal data may be available but is less capable and/or more costly. In the context of a project management application, a transcript may include personal data such as names of persons (including the information that they are working on something or doing something) and/or personal information being discussed in meetings or chats. Accordingly, method 1100 may be performed to sanitize the transcript data by removing any personal data therein before the transcript or any portion thereof is processed by an LLM, thereby reducing the amount of personal data being exposed to the LLM.

As shown, an input 1102 which contains potentially personal data is submitted to a model 1104, which may be another LLM. As indicated, model 1104 detects personal data in human language and is compliant to receive personal data but usually is higher in cost or less capable than a non-compliant model.

The model 1104 may be configured to provide a summary of the text portions containing personal data with focus on removing any details that may cause personal data to be identified to a single person. Alternatively, the model 1104 may filter the information with prompts such as: “provide a filtered output of this conversation but remove any potentially private conversation therein.”

At 1106, any real names in the input data are replaced by the model with other names from a list of known names. The other names may be random fake names, for example. Towards this end, names in standardized positions (e.g., the speaker names in a transcript) may be removed first, anonymized (e.g. speaker 1, speaker 2, etc.), or replaced with fake names. As indicated, a relationship between the fake names and the real names may be stored in a database 1108 such that the fake names can later be replaced with the real names in the result. Towards this end, it may be specified that the first and last name be unique within one prompt to always ensure the ability to map back. Further, phonetically similar random names within the same prompt for two different persons may be avoided by checking the phonetic distance of the involved names and in case of doubt choosing a different random name.

At 1110, the model removes personal data from the input 1102 or replaces the personal data with a static placeholder such as “XXX”. Alternatively, the personal data may be replaced by a sentence such as “The following data cannot be provided as it contains personal data.”

The resulting modified version of 1102 (i.e., the input 1102 as modified by steps 1106 and 1110) can be referred to as sanitized input, as shown at 1112. The sanitized input is then input to a prompt template at 1114 (e.g., a template for one of the prompts described herein), which in turn is submitted to an LLM at 1116. In contrast to the model used at 1104 to sanitize the input data, the LLM receiving the sanitized input at 1116 may be non-compliant to receive personal data.

The LLM then generates output which undergoes further processing at 1118 to replace any fake names that had been used in the sanitized input with the real names. As shown, this can include accessing the database 1108 to obtain the real names and the relationships between the real names and the fake names. At this stage, processing of the input continues (e.g., starting at step 406 of method 400).

In other examples, rather than sanitizing the input, the input may be rejected as including personal data. Alternatively, a user may be prompted to indicate whether they are okay with the risk of potentially submitting personal data to LLMs.

### Example 15—Example Method Employing an AI-Assisted Chatbot to Clarify task Information

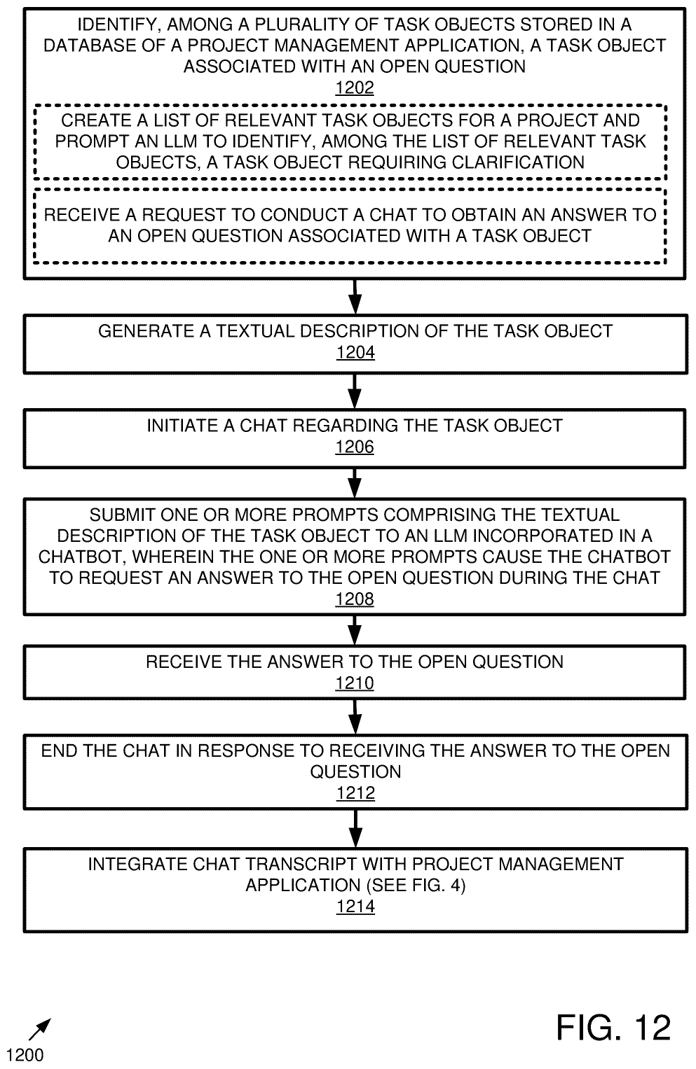

FIG. 12 is a flowchart of an example method 1200 of employing an AI-assisted chatbot to obtain clarification of task information in conjunction with the technologies described herein and can be performed, for example, by the system of FIG. 2. Method 1200 may be performed in conjunction with, and overlap with, method 400 of FIG. 4. For example, a transcript of a chat performed by the chatbot may be input to method 400 for integration of the information therein with the project management application.

At 1202, the method includes identifying, among a plurality of task objects stored in a database of a project management application, a task object associated with an open question (e.g., a task object where there is potential need for further communication). As indicated, identifying a task object associated with an open question this can optionally include creating a list of relevant task objects for a project and prompting an LLM to identify, among the list of relevant task objects, a task object requiring clarification. In theory, all tasks of the project could be processed. However, this may be inefficient; for example, closed tasks may have no need for processing.

Accordingly, the list of relevant task objects may be generated based on factors such as the last updates time of the task objects, the status of the associated tasks, the due date of the associated tasks, etc. Then, the LLM can be prompted to indicate which task objects, among the list of relevant task objects, require attention (e.g., which task objects are associated with open questions that could be answered by direct communication). An example LLM prompt that could be submitted individually for each task identified as relevant may look like this:

“Here is a description of a task:
Name: ?taskname?
Assignee: ?assignee?
Status: ?status?
Comments and Status Updates:
?xdays? ago by ?person?: ?comment or status update?
?xdays? ago by ?person?: ?comment or status update?
------
Are there open topics based on this information? Do not make
something up. Only topics that are clearly identified based on the
provided information. Please respond with the JSON array
[{topic_description:″″, why_interesting:″″ }]””

Alternatively, the LLM prompt can request identification of multiple tasks at a time. Such an example prompt may look like this:
“I want you to act as an intelligent project assistant and tasked to identify tasks where you as chat bot should initiate a short chat conversation with the assignee to clarify potentially open questions. You will be presented the list of tasks of the project. Initiate the conversation if there is information that could potentially be retrieved from the assignee via a simple chat. If there is a potential risk and the assignee could report on that it is also worth starting the conversation. Then return the description, taskId, assignee, assigneeId and the reason for the conversation for every relevant task. The result must be in the following

json format: { ″tasks: [
{“description″:””,”taskId”:””,”assignee”:””,”assigneeId”:””,”reasonFor
Conversation”:”” }] } No additional text, only return the json object.
Only status update relevant questions. Don't make something up. Only
return tasks where conversation is required.
UserPrompt:
Name: ?taskname?
Assignee: ?assignee?
Status: ?status?
Comments and Status Updates:
?xdays? ago by ?person?: ?comment or status update?
?xdays? ago by ?person?: ?comment or status update?
---...”

A scheduled job may run periodically in a project management application to check if further communications are required regarding any of the task objects stored. Put another way, the IPA can monitor open tasks to determine if a direct one-on-one chat with the assigned individual could yield additional necessary information.

Alternatively or additionally, identifying a task object associated with an open question at 1202 can include receiving a request to conduct a chat to obtain an answer to an open question associated with a task object. For example, a user (e.g., a project manager) may recognize that additional clarification would be helpful for a particular task. The user may then submit a request (e.g., to the IPA) to deploy a chatbot to conduct a chat with a user assigned to the task to obtain answers to one or more open questions regarding the task.

At 1204, a textual description of the task object is generated (e.g., based on the available structured data). For example, after identifying the task object associated with the open question, the IPA may generate a textual description of the task object which can later serve as an input to an LLM incorporated in a chatbot. The textual description of the task object can include, for example, status updates, comments, due dates, and priorities associated with the task object. To give the LLM a feel of time, either the current date may be added, or date values may be provided in days since/until today instead of the exact date.

At 1206, a chat is initiated regarding the task object. For example, the IPA can initiate a chat between a chatbot and a specified user of the project management application. The IPA can then submit one or more prompts to an LLM incorporated in the chatbot at 1208. Each prompt can include the textual description of the task object generated at 1204. As indicated, the one or more prompts can cause the chatbot to request an answer to the open question during the chat. In some examples, the chat conversation may be initiated and maintained using APIs with an online communication tool.

An example prompt that the IPA may submit to the LLM to formulate the first message to be sent in the chat may look like this:
“You are an intelligent project communication assistant and tasked to chat with?assignee? the assignee of the task “?taskname?”.
The following topics you want to receive updates/new information from the assignee on:
?list of topics e.g. one topic per line, start with-?
There has been no conversation yet. This is the first message.
Please provide a JSON with the message you want to send to?assignee?in the following format {nextmessage:” . . . “, reason:””}.”

The first message for the chat may be sent, via the API, to the user. The chatbot then awaits a response. Either a response is received, or a timeout is reached, at which point the IPA determines whether the chat can be ended. Towards this end, the LLM can be prompted to check if all the previously asked questions have been addressed such that the chat can be ended. To prevent endless loops, the chatbot may be configured to end the chat after a defined number of messages have been exchanged or if a timeout with no response is reached. A grace period can also be implemented in which the user is asked specifically whether the chat can be closed. In this instance, an example prompt to the LLM might look like this:

“You are an intelligent project communication assistant and tasked to
chat with ?opponentname? the assignee of the task “?taskname?”. Note,
that you won't be able to help in any way and you also can not establish
a conversation to come back with further information.
The following is the questions/topics you wanted to get answers on
during the chat:
?questions?
This is the conversation so far:
?You: ...
OpponentName: ....?
---
How shall we continue with this conversation. Should it be ended now
or is there anything else to be checked. Remember you cannot help
Johanna, the only thing you can do is collect the information and this
will then be made available to the project manager in a summarized
form. Please answer these questions by providing a json with this
format:
{end_chat_after_this_next_message:boolean,
nextmessage:”..”,reason:””}””

The result can then be assessed to determine whether this is the last message of the conversation, or if the loop should be continued.

At 1210, an answer to the open question is received. In response to receiving the answer to the open question, the IPA can instruct the chatbot to end the chat at 1212. At 1214, a transcript of the chat is integrated with the project management application. For example, method 400 of FIG. 4 can be performed for the chat transcript such that the information therein can be stored in the database, either as an update to an existing task object or as a new task object.

Accordingly, a chatbot incorporating an LLM can be employed to conduct one-on-one chats with users of a project management application to obtain clarification regarding tasks. The chats can be initiated via an automatic process (e.g., a process in which an LLM identifies task(s) requiring further clarification), or in response to user input. Once the chat is finished, the information therein is summarized and stored against the task objects of the project management application in a structured format. A user (e.g., a project manager) can then access the resulting information from the UI of the project management application, review the proposed changes, and choose to accept or reject them.

### Example 16—Example UI Displaying Proposed Update from Chatbot Chat

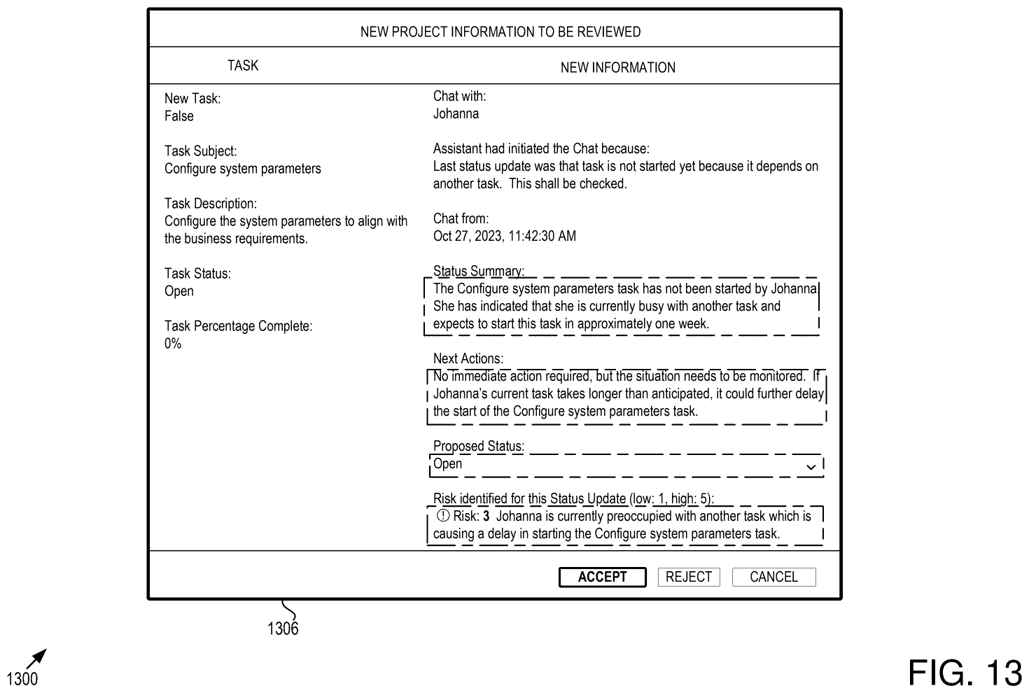

FIG. 13 is a block diagram of an example UI 1300 displaying a proposed task update generated based on a chat conducted by a chatbot.

In this example, the IPA has identified (via an automatic scheduled process, based on user input, or in another manner) that the task “Configure system parameters” assigned to project team member Johanna has been missing a status update for an extended period and that an unanswered question regarding her readiness to start the task has been pending for some time. Consequently, the IPA initiated a personal chat with Johanna to resolve these issues by employing a chatbot incorporating an LLM. During the chat, Johanna initially responded with a concise message. However, the IPA determined that her response didn't address all the pending queries related to the task and replied with a follow up question. The IPA formulated the follow up question with the goal of resolving all open points that required a status update. Johanna then provided a more comprehensive response to the follow up question including an explanation of why she had not yet started the task. The IPA maintained the conversation until all significant open points are addressed. Following this, the IPA concluded the chat and transformed the conversation into an IPA suggestion including a proposed status update, much like it does with meeting transcripts. The resulting proposed status update is shown in window 1306.

Window 1306 includes information similar to that described above with reference to window 506 of FIG. 5. However, whereas window 506 indicated that the new information originated from a meeting transcript, window 1306 indicates that the new information originated from a chat with user Johanna (along with the reasons the IPA initiated the chat). In the example, the chat was initiated by the IPA because the last status update for the task was that the task was not started yet because it depends on another task. The date and time the chat was conducted is also indicated in window 1306.

As shown, the IPA has generated a proposed status summary, proposed next actions, proposed status, and proposed risk for the task “Configure system parameters” based on a transcript of the chat. Here again, the window 1306 displays the proposed updates to be incorporated in editable fields such that the user can select each editable field to adjust the suggestion as appropriate.

### Example 17—Example Architecture Overview

In any of the examples herein, the task objects, status update entities, new task entities, and transcripts can be stored internally as data structures, tables, or the like in a computing system. In practice, each entity can be represented as a node, and relationships between nodes can be stored. Such nodes can take the form of logical objects that have properties and executable methods according to object-oriented programming paradigm. The data can be represented in data structures, database tables, or the like.

While the techniques described herein refer to task objects in particular, similar techniques may be applied to other data objects. For example, the techniques described herein may also be applied to project management data objects associated with project plan elements, issues, risks, etc.

### Example 18—Example Implementations

Any of the following can be implemented.

Clause 1. A computer-implemented method comprising: receiving a transcript of communications; submitting a prompt to a Large Language Model (LLM), the prompt comprising the transcript and a request for the LLM to identify one or more tasks discussed in the transcript and generate, for each task, a structured output comprising a summary of the task and a next action for the task; receiving a structured output for a first task of the one or more tasks from the LLM in response to the prompt; mapping the first task to a corresponding first task object stored in a database based at least in part on the structured output for the first task; storing the structured output for the first task in the database in a status update entity linked to the first task object; displaying, via a user interface, data from the status update entity as a proposed update to the first task object; receiving, via the user interface, an input accepting the proposed update; and updating the first task object with the data from the status update entity in response to the input accepting the proposed update.

Clause 2. The method of Clause 1, wherein the transcript comprises unstructured communication data regarding the one or more tasks.

Clause 3. The method of Clause 2, wherein the prompt further comprises a request for the LLM to generate, as part of the structured output for each task, at least one of: a current status of the task; a proposed status change for the task; a start time and an end time of discussion of the task in the transcript; a name of a user to whom the task is assigned; a summary of the discussion of the task; or a summary of action items identified for the task.

Clause 4. The method of any one of Clauses 1-3, further comprising, after displaying the status update entity as the proposed update via the user interface: receiving, via the user interface, an input requesting one or more adjustments to the data from the status update entity; and modifying the status update entity based on the requested one or more adjustments; wherein updating the first task object with the data from the status update entity is performed after the modifying of the status update entity.

Clause 5. The method of any one of Clauses 1-4, wherein updating the task object with the data from the status update entity comprises updating one or more task attributes of the task object based on the data from the status update entity.

Clause 6. The method of any one of Clauses 1-5, wherein the prompt is a first prompt, and wherein mapping the first task to the corresponding task object comprises: generating a second prompt for the LLM to search the database for the corresponding task object, the second prompt comprising: a list of existing task objects stored in the database; data attributes of the first task derived from the structured output for the first task; and a request to search the list of existing task objects and return either an identifier of a task object having data attributes matching the data attributes of the first task or an empty string if no match is found.

Clause 7. The method of Clause 6, wherein the list of existing task objects is a subset of all existing task objects stored in the database, the method further comprising generating the list of existing task objects by filtering the existing task objects stored in the database based on at least one of: a creation date; an edit date; a status; a latest comment; a latest status update; or a name of an associated user.

Clause 8. The method of Clause 7, wherein the list of existing task objects is a subset of all existing tasks stored in the database, the method further comprising: for each existing task object in the list of existing objects, pre-creating an embedding vector for the existing task object based at least in part on data attributes of the existing task object; storing the embedding vectors; creating a search embedding vector for the first task based on the data attributes of the first task; and generating the list of existing task objects by retrieving a predefined number of the existing tasks stored in the database whose respective embedding vectors are most closely related to the search embedding vector.

Clause 9. The method of any one of Clauses 1-8, further comprising: receiving a structured output for a second task of the one or more tasks from the LLM in response to the prompt; determining that the second task does not correspond to any existing task objects stored in the database; storing the structured output for the second task in the database in a new task entity; displaying, via the user interface, data from the new task entity; receiving, via the user interface, an input accepting the data from the new task entity; and creating a new task object in the database and populating the new task object with the data from the new task entity in response to the input accepting the data from the new task entity.

Clause 10. The method of Clause 9, wherein the prompt is a first prompt, the method further comprising, after populating the new task object with the data from the new task entity: submitting a second prompt to the LLM comprising the transcript and a request for the LLM to generate task description text for the new task object; receiving the task description text from the LLM in response to the second prompt; and adding the task description text to the new task object.

Clause 11. The method of any one of Clauses 1-10, wherein the LLM is a first LLM, the method further comprising: prior to submitting the prompt to the first LLM, submitting a prompt to a second LLM, the prompt submitted to the second LLM comprising the transcript and a request for the second LLM to identify personal data in the transcript and output a sanitized version of the transcript with the personal data removed, wherein the transcript included in the prompt submitted to the first LLM is the sanitized version of the transcript.

Clause 12. The method of any one of Clauses 1-11, wherein the transcript is a segment of a longer transcript of communications, the method further comprising: prior to receiving the transcript, generating the transcript by applying the LLM to divide the longer transcript into a plurality of segments, wherein each of the plurality of segments encapsulates a discussion of a respective one of a plurality of different topics.

Clause 13. The method of any one of Clauses 2-12, wherein the transcript comprises at least one of: a meeting transcript; a transcript of an online chat session between at least two users; or a transcript of an online chat session between a chatbot that incorporates the LLM and a user.

Clause 14. A computing system comprising: at least one hardware processor; at least one memory coupled to the at least one hardware processor, the at least one memory comprising a database storing a plurality of task objects; a large language model (LLM); and one or more non-transitory computer-readable media having stored therein computer-executable instructions that, when executed by the computing system, cause the computing system to perform: receiving a transcript comprising unstructured communication data; dividing the transcript into a plurality of segments; for each segment of the plurality of segments, submitting a prompt to the LLM, the prompt comprising the segment and a request for the LLM to identify one or more tasks discussed in the transcript and generate, for each task, a structured output comprising a summary of the task and a next action for the task; receiving a structured output for a first task of the one or more tasks from the LLM in response to the prompt; mapping the first task to a corresponding first task object stored in a database based at least in part on the structured output for the first task; and storing the structured output for the first task in the database in a status update entity linked to the first task object.

Clause 15. The system of Clause 14, wherein the prompt is a first prompt, and wherein dividing the transcript into the plurality of segments comprises: dividing the transcript into a first set of candidate segments, each candidate segment of the first set of candidate segments corresponding to respective one of a plurality of consecutive time intervals; dividing the transcript into a second set of candidate segments, each candidate segment of the second set of candidate segments corresponding to a respective one of a plurality of overlapping time intervals; and for each of the candidate segments in the first set of candidate segments and the second set of candidate segments, submitting a second prompt to the LLM, the second prompt comprising the candidate segment and a request to generate a structured output for the candidate segment comprising a start time of the candidate segment, an end time of the candidate segment, and a summary of the candidate segment.

Clause 16. The system of Clause 15, wherein the computer-executable instructions further comprise computer-executable instructions that, when executed by the computing system, cause the computing system to perform: for each of the candidate segments in the first set of candidate segments and second sets of candidate segments, receiving the structured output for the candidate segment from the LLM in response to the second prompt; and matching the candidate segments in the first set of candidate segments to the candidate segments in the second set of candidate segments based at least in part on the structured outputs for the first set of candidate segments to obtain the plurality of segments, wherein each of the plurality of segments encapsulates a discussion of a respective one of a plurality of different topics.

Clause 17. The system of any one of Clauses 1-16, further comprising a stored representation of a plurality of task groups, wherein each of the plurality of stored task objects is associated with a corresponding task group of the plurality of task groups, and wherein the computer-executable instructions comprise computer-executable instructions that, when executed by the computing system, cause the computing system to perform: mapping the transcript to a corresponding task group of the plurality of task groups.

Clause 18. The system of Clause 17, wherein the transcript comprises at least one of: a transcript of a meeting regarding the corresponding task group; a transcript of a user-initiated online chat session regarding the corresponding task group; or a transcript of a chatbot-initiated online chat session regarding the corresponding task group.

Clause 19. One or more non-transitory computer-readable media storing computer-executable instructions, the instructions comprising: first instructions to identify, among a plurality of task objects stored in a database of a software application, a task object associated with an open question; second instructions to generate a textual description of the task object; third instructions to initiate a chat regarding the task object; fourth instructions to submit one or more prompts comprising the textual description of the task object to a Large Language Model (LLM) incorporated in a chatbot, wherein the one or more prompts cause the chatbot to request an answer to the open question during the chat; fifth instructions to end the chat in response to receiving the answer to the open question; sixth instructions to create a structured output based on a transcript of the chat; and seventh instructions to store data from the structured output in a status update entity linked to the task object in the database.

Clause 20. The computer-readable media of Clause 19, wherein the task object is identified by the LLM in response to a prompt comprising a request to identify which of the plurality of task objects require clarification, or wherein the task object is identified in response to a request for clarification of the task object received via a user interface of the software application.

### Example 19—Example Advantages

A number of advantages can be achieved via the technologies described herein. For example, providing automated of task status tracking makes it possible for project managers to concentrate on project managing instead of capturing status updates into structured data structures in the project management system. Further, the status updates can be captured and integrated during meetings that the project manager does not attend.

Further, by enabling unstructured status information to be automatically gathered and transformed into structured information, the technologies described herein lead to more status information being incorporated in the project management system with better data quality. Accordingly, the reporting on such data will lead to better decisions made in projects.

As another example, employing an LLM to assist in determining tasks whose status requires clarification can help to identify gaps in status data that the project manager might otherwise overlook. Such gaps can then be filled without user intervention (e.g., without action by the project manager) by employing a chatbot incorporating an LLM to actively initiate chats with project team members to obtain missing information.

### Example 20—Example Computing Systems

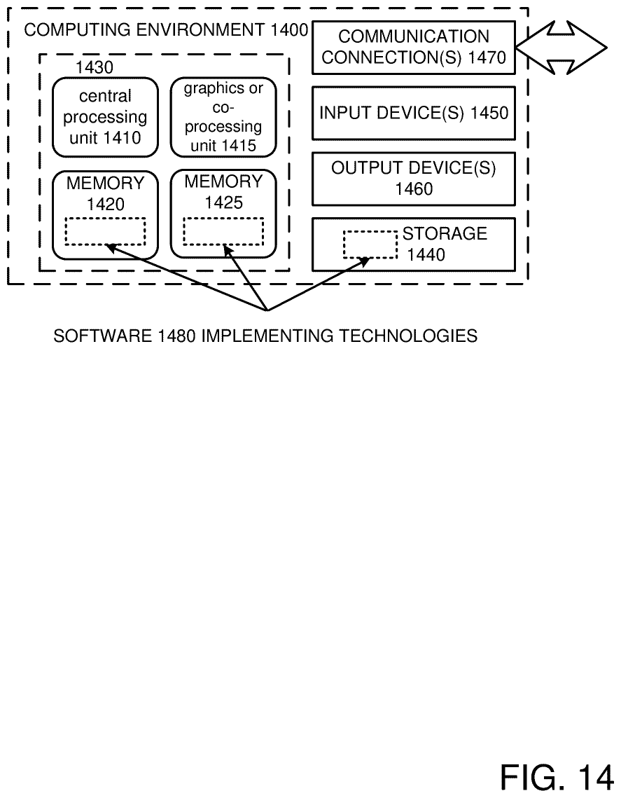

FIG. 14 depicts an example of a suitable computing system 1400 in which the described innovations can be implemented. The computing system 1400 is not intended to suggest any limitation as to scope of use or functionality of the present disclosure, as the innovations can be implemented in diverse computing systems.

With reference to FIG. 14, the computing system 1400 includes one or more processing units 1410, 1415 and memory 1420, 1425. In FIG. 14, this basic configuration 1430 is included within a dashed line. The processing units 1410, 1415 execute computer-executable instructions, such as for implementing the features described in the examples herein. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 14 shows a central processing unit 1410 as well as a graphics processing unit or co-processing unit 1415. The tangible memory 1420, 1425 can be volatile memory (e.g., registers, cache, RAM), non-volatile memory (e.g., ROM, EEPROM, flash memory, etc.), or some combination of the two, accessible by the processing unit(s) 1410, 1415. The memory 1420, 1425 stores software 1480 implementing one or more innovations described herein, in the form of computer-executable instructions suitable for execution by the processing unit(s) 1410, 1415.

A computing system 1400 can have additional features. For example, the computing system 1400 includes storage 1440, one or more input devices 1450, one or more output devices 1460, and one or more communication connections 1470, including input devices, output devices, and communication connections for interacting with a user. An interconnection mechanism (not shown) such as a bus, controller, or network interconnects the components of the computing system 1400. Typically, operating system software (not shown) provides an operating environment for other software executing in the computing system 1400, and coordinates activities of the components of the computing system 1400.

The tangible storage 1440 can be removable or non-removable, and includes magnetic disks, magnetic tapes or cassettes, CD-ROMs, DVDs, or any other medium which can be used to store information in a non-transitory way and which can be accessed within the computing system 1400. The storage 1440 stores instructions for the software 1480 implementing one or more innovations described herein.

The input device(s) 1450 can be an input device such as a keyboard, mouse, pen, or trackball, a voice input device, a scanning device, touch device (e.g., touchpad, display, or the like) or another device that provides input to the computing system 1400. The output device(s) 1460 can be a display, printer, speaker, CD-writer, or another device that provides output from the computing system 1400.

The communication connection(s) 1470 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the context of computer-executable instructions, such as those included in program modules, being executed in a computing system on a target real or virtual processor (e.g., which is ultimately executed on one or more hardware processors). Generally, program modules or components include routines, programs, libraries, objects, classes, components, data structures, etc. that perform particular tasks or implement particular abstract data types. The functionality of the program modules can be combined or split between program modules as desired in various embodiments. Computer-executable instructions for program modules can be executed within a local or distributed computing system.

For the sake of presentation, the detailed description uses terms like “determine” and “use” to describe computer operations in a computing system. These terms are high-level descriptions for operations performed by a computer and should not be confused with acts performed by a human being. The actual computer operations corresponding to these terms vary depending on implementation.

### Example 21—Example Integration into Software

In any of the examples herein, the technologies can be integrated into data management software. For example, SAP S/4 HANA Cloud for Projects available from SAP SE of Walldorf, Germany can incorporate the features described herein to facilitate integration of unstructured transcript data.

### Example 22—Computer-Readable Media

Any of the computer-readable media herein can be non-transitory (e.g., volatile memory such as DRAM or SRAM, nonvolatile memory such as magnetic storage, optical storage, or the like) and/or tangible. Any of the storing actions described herein can be implemented by storing in one or more computer-readable media (e.g., computer-readable storage media or other tangible media). Any of the things (e.g., data created and used during implementation) described as stored can be stored in one or more computer-readable media (e.g., computer-readable storage media or other tangible media). Computer-readable media can be limited to implementations not consisting of a signal.

Any of the methods described herein can be implemented by computer-executable instructions in (e.g., stored on, encoded on, or the like) one or more computer-readable media (e.g., computer-readable storage media or other tangible media) or one or more computer-readable storage devices (e.g., memory, magnetic storage, optical storage, or the like). Such instructions can cause a computing system to perform the method. The technologies described herein can be implemented in a variety of programming languages.

### Example 23—Example Cloud Computing Environment

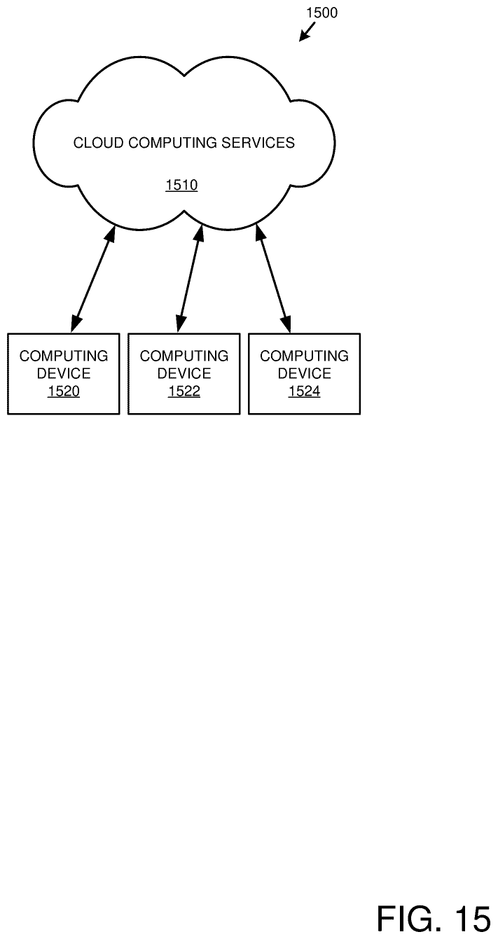

FIG. 15 depicts an example cloud computing environment 1500 in which the described technologies can be implemented, including, e.g., the system 100 of FIG. 1 and other systems herein. The cloud computing environment 1500 comprises cloud computing services 1510. The cloud computing services 1510 can comprise various types of cloud computing resources, such as computer servers, data storage repositories, networking resources, etc. The cloud computing services 1510 can be centrally located (e.g., provided by a data center of a business or organization) or distributed (e.g., provided by various computing resources located at different locations, such as different data centers and/or located in different cities or countries).

The cloud computing services 1510 are utilized by various types of computing devices (e.g., client computing devices), such as computing devices 1520, 1522, and 1524. For example, the computing devices (e.g., 1520, 1522, and 1524) can be computers (e.g., desktop or laptop computers), mobile devices (e.g., tablet computers or smart phones), or other types of computing devices. For example, the computing devices (e.g., 1520, 1522, and 1524) can utilize the cloud computing services 1510 to perform computing operations (e.g., data processing, data storage, and the like).

In practice, cloud-based, on-premises-based, or hybrid scenarios can be supported.

### Example 24—Example Implementations

Although the operations of some of the disclosed methods are described in a particular, sequential order for convenient presentation, such manner of description encompasses rearrangement, unless a particular ordering is required by specific language set forth herein. For example, operations described sequentially can in some cases be rearranged or performed concurrently.

### Example 25—Example Alternatives

The technologies from any example can be combined with the technologies described in any one or more of the other examples. In view of the many possible embodiments to which the principles of the disclosed technology can be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A computer-implemented method comprising:
receiving a transcript of communications;
submitting a prompt to a Large Language Model (LLM), the prompt comprising the transcript and a request for the LLM to identify one or more tasks discussed in the transcript and generate, for each task, a structured output comprising a summary of the task and a next action for the task;
receiving a structured output for a first task of the one or more tasks from the LLM in response to the prompt;
mapping the first task to a corresponding first task object stored in a database based at least in part on the structured output for the first task;
storing the structured output for the first task in the database in a status update entity linked to the first task object;
displaying, via a user interface, data from the status update entity as a proposed update to the first task object;
receiving, via the user interface, an input accepting the proposed update; and
updating the first task object with the data from the status update entity in response to the input accepting the proposed update.

2. The method of claim 1, wherein the transcript comprises unstructured communication data regarding the one or more tasks.

3. The method of claim 2, wherein the prompt further comprises a request for the LLM to generate, as part of the structured output for each task, at least one of:
a current status of the task;
a proposed status change for the task;
a start time and an end time of discussion of the task in the transcript;
a name of a user to whom the task is assigned;
a summary of the discussion of the task; or
a summary of action items identified for the task.

4. The method of claim 1, further comprising, after displaying the status update entity as the proposed update via the user interface:
receiving, via the user interface, an input requesting one or more adjustments to the data from the status update entity; and
modifying the status update entity based on the requested one or more adjustments;
wherein updating the first task object with the data from the status update entity is performed after the modifying of the status update entity.

5. The method of claim 1, wherein updating the task object with the data from the status update entity comprises updating one or more task attributes of the task object based on the data from the status update entity.

6. The method of claim 1,
wherein the prompt is a first prompt, and
wherein mapping the first task to the corresponding task object comprises:
generating a second prompt for the LLM to search the database for the corresponding task object, the second prompt comprising:
a list of existing task objects stored in the database;
data attributes of the first task derived from the structured output for the first task; and
a request to search the list of existing task objects and return either an identifier of a task object having data attributes matching the data attributes of the first task or an empty string if no match is found.

7. The method of claim 6, wherein the list of existing task objects is a subset of all existing task objects stored in the database, the method further comprising generating the list of existing task objects by filtering the existing task objects stored in the database based on at least one of:
a creation date;
an edit date;
a status;
a latest comment;
a latest status update; or
a name of an associated user.

8. The method of claim 7, wherein the list of existing task objects is a subset of all existing tasks stored in the database, the method further comprising:
for each existing task object in the list of existing objects, pre-creating an embedding vector for the existing task object based at least in part on data attributes of the existing task object;
storing the embedding vectors;
creating a search embedding vector for the first task based on the data attributes of the first task; and
generating the list of existing task objects by retrieving a predefined number of the existing tasks stored in the database whose respective embedding vectors are most closely related to the search embedding vector.

9. The method of claim 1, further comprising:
receiving a structured output for a second task of the one or more tasks from the LLM in response to the prompt;
determining that the second task does not correspond to any existing task objects stored in the database;
storing the structured output for the second task in the database in a new task entity;
displaying, via the user interface, data from the new task entity;
receiving, via the user interface, an input accepting the data from the new task entity; and
creating a new task object in the database and populating the new task object with the data from the new task entity in response to the input accepting the data from the new task entity.

10. The method of claim 9, wherein the prompt is a first prompt, the method further comprising, after populating the new task object with the data from the new task entity:
submitting a second prompt to the LLM comprising the transcript and a request for the LLM to generate task description text for the new task object;
receiving the task description text from the LLM in response to the second prompt; and
adding the task description text to the new task object.

11. The method of claim 1, wherein the LLM is a first LLM, the method further comprising:
prior to submitting the prompt to the first LLM, submitting a prompt to a second LLM, the prompt submitted to the second LLM comprising the transcript and a request for the second LLM to identify personal data in the transcript and output a sanitized version of the transcript with the personal data removed,
wherein the transcript included in the prompt submitted to the first LLM is the sanitized version of the transcript.

12. The method of claim 1, wherein the transcript is a segment of a longer transcript of communications, the method further comprising:
prior to receiving the transcript, generating the transcript by applying the LLM to divide the longer transcript into a plurality of segments, wherein each of the plurality of segments encapsulates a discussion of a respective one of a plurality of different topics.

13. The method of claim 2, wherein the transcript comprises at least one of:
a meeting transcript;
a transcript of an online chat session between at least two users; or
a transcript of an online chat session between a chatbot that incorporates the LLM and a user.

14. A computing system comprising:
at least one hardware processor;
at least one memory coupled to the at least one hardware processor, the at least one memory comprising a database storing a plurality of task objects;
a large language model (LLM); and
one or more non-transitory computer-readable media having stored therein computer-executable instructions that, when executed by the computing system, cause the computing system to perform:
receiving a transcript comprising unstructured communication data;
dividing the transcript into a plurality of segments;
for each segment of the plurality of segments, submitting a prompt to the LLM, the prompt comprising the segment and a request for the LLM to identify one or more tasks discussed in the transcript and generate, for each task, a structured output comprising a summary of the task and a next action for the task;
receiving a structured output for a first task of the one or more tasks from the LLM in response to the prompt;
mapping the first task to a corresponding first task object stored in a database based at least in part on the structured output for the first task; and
storing the structured output for the first task in the database in a status update entity linked to the first task object.

15. The system of claim 14,
wherein the prompt is a first prompt, and
wherein dividing the transcript into the plurality of segments comprises:
dividing the transcript into a first set of candidate segments, each candidate segment of the first set of candidate segments corresponding to respective one of a plurality of consecutive time intervals;
dividing the transcript into a second set of candidate segments, each candidate segment of the second set of candidate segments corresponding to a respective one of a plurality of overlapping time intervals; and
for each of the candidate segments in the first set of candidate segments and the second set of candidate segments, submitting a second prompt to the LLM, the second prompt comprising the candidate segment and a request to generate a structured output for the candidate segment comprising a start time of the candidate segment, an end time of the candidate segment, and a summary of the candidate segment.

16. The system of claim 15, wherein the computer-executable instructions further comprise computer-executable instructions that, when executed by the computing system, cause the computing system to perform:
for each of the candidate segments in the first set of candidate segments and second sets of candidate segments, receiving the structured output for the candidate segment from the LLM in response to the second prompt; and
matching the candidate segments in the first set of candidate segments to the candidate segments in the second set of candidate segments based at least in part on the structured outputs for the first set of candidate segments to obtain the plurality of segments, wherein each of the plurality of segments encapsulates a discussion of a respective one of a plurality of different topics.

17. The system of claim 14, further comprising a stored representation of a plurality of task groups,
wherein each of the plurality of stored task objects is associated with a corresponding task group of the plurality of task groups, and
wherein the computer-executable instructions comprise computer-executable instructions that, when executed by the computing system, cause the computing system to perform:
mapping the transcript to a corresponding task group of the plurality of task groups.

18. The system of claim 17, wherein the transcript comprises at least one of:
a transcript of a meeting regarding the corresponding task group;
a transcript of a user-initiated online chat session regarding the corresponding task group; or
a transcript of a chatbot-initiated online chat session regarding the corresponding task group.

19. One or more non-transitory computer-readable media storing computer-executable instructions, the instructions comprising:
first instructions to identify, among a plurality of task objects stored in a database of a software application, a task object associated with an open question;
second instructions to generate a textual description of the task object;
third instructions to initiate a chat regarding the task object;
fourth instructions to submit one or more prompts comprising the textual description of the task object to a Large Language Model (LLM) incorporated in a chatbot, wherein the one or more prompts cause the chatbot to request an answer to the open question during the chat;
fifth instructions to end the chat in response to receiving the answer to the open question;
sixth instructions to create a structured output based on a transcript of the chat; and
seventh instructions to store data from the structured output in a status update entity linked to the task object in the database.

20. The computer-readable media of claim 19,
wherein the task object is identified by the LLM in response to a prompt comprising a request to identify which of the plurality of task objects require clarification, or
wherein the task object is identified in response to a request for clarification of the task object received via a user interface of the software application.
